(19) United States
(12) Patent Application Publication
(10) Pub. No.: US 2016/0055537 A1
(43) Pub. Date: Feb. 25, 2016

(54) TECHNIQUES TO TARGET AND COMMUNICATE MOBILE OFFERS

(71) Applicant: Onavo Mobile Ltd., Menlo Park, CA (US)

(72) Inventors: Roi Tiger, Tel Aviv (IL); Erbil Karaman, San Francisco, CA (US); Guy Rosen, Sunnyvale, CA (US); Lior Tubi, Tel Aviv (IL); Praveen Arichandran, Redwood City, CA (US)

(73) Assignee: ONAVO MOBILE LTD., Menlo Park, CA (US)

(21) Appl. No.: 14/574,479

(22) Filed: Dec. 18, 2014

Related U.S. Application Data
(60) Provisional application No. 62/040,562, filed on Aug. 22, 2014.

(51) Int. Cl. G06Q 30/02; H04L 29/12; G06Q 50/00

(52) U.S. Cl. CPC G06Q 30/0267; G06Q 50/01; H04L 61/6054

(57) ABSTRACT

Techniques to target and communicate mobile offers are described. Some embodiments are particularly directed to techniques to techniques to target and communicate mobile offers using member information from a social-networking service. In one embodiment, for example, an apparatus may comprise a customer selection component, a channel selection component, and an offer customization component. The customer selection component may be operative to retrieve an offer from an offers store, the offer associated with offer selection criteria, and search a user information store to select a mobile user based on a match between the offer selection criteria and user information for the mobile user stored in the user information store. Other embodiments are described and claimed.

### RELATED CASES

This is a non-provisional patent application that claims the benefit of, and priority to, U.S. Provisional Patent Application No. 61/040,562 titled “Techniques To Target And Communicate Mobile Offers,” filed on Aug. 22, 2014, which is hereby incorporated by reference in its entirety.

### BACKGROUND

Mobile devices, such as cellular telephones, may be configured for access to a cellular network using a subscriber identity module (SIM). Some SIMs may be individually registered as belonging to an individual customer, such as where a subscriber contract is created between an individual customer and a cellular provider. Other SIMs may be purchased or registered en masse and then sold for pre-paid use, in which the ultimate individual customer does not have a subscriber contract with the cellular provider.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

Various embodiments are generally directed to techniques to target and communicate mobile offers. Some embodiments are particularly directed to techniques to techniques to target and communicate mobile offers using member information from a social-networking service. In one embodiment, for example, an apparatus may comprise a customer selection component, a channel selection component, and an offer customization component. The customer selection component may be operative to retrieve an offer from an offers store, the offer associated with an offer identifier, the offer associated with offer selection criteria, search a user information store to select a mobile user based on a match between the offer selection criteria and user information for the mobile user stored in the user information store, transmit, via a network interface, the offer to a mobile device associated with the mobile user, the mobile device identified by a mobile device identifier, the mobile device associated with a cellular provider for mobile service, receive, via the network interface, an acceptance of the offer from the mobile device, and transmit, via the network interface, a purchase order to the cellular provider, the purchase order comprising the offer identifier and the mobile device identifier, the purchase order indicating the acceptance of the offer to the cellular provider. Other embodiments are described and claimed.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates an embodiment of a mobile offer communication system.

FIG. 2 illustrates an embodiment of a mobile device for use with the mobile offer communication system.

FIG. 3 illustrates an embodiment of a mobile offers server for use with the mobile offer communication system.

FIG. 4 illustrates an embodiment of the mobile offers server selecting a mobile user to receive an offer.

FIG. 5 illustrates an embodiment of the mobile offers server selecting a channel for communicating with a mobile user.

FIG. 6 illustrates an embodiment of the mobile offers server customizing an offer to a mobile user.

FIG. 7 illustrates an embodiment of a logic flow for the system of FIG. 1.

FIG. 8 illustrates an embodiment of a centralized system for the system of FIG. 1.

FIG. 9 illustrates an embodiment of a distributed system for the system of

FIG. 10 illustrates an embodiment of a computing architecture.

FIG. 11 illustrates an embodiment of a communications architecture.

FIG. 12 illustrates an embodiment of a radio device architecture.

### DETAILED DESCRIPTION

Various embodiments are directed to techniques to target and communicate mobile offers. Some customers may purchase mobile devices, such as cellular telephones, within a consumer system that denies significant biographical data about the customer to the cellular provider providing service to the device. A customer may purchase a pre-paid cell phone with a SIM card included, where no biographical data about the customer is provided to the seller and therefore upwards to the cellular provider. Similarly, a customer may purchase a pre-paid SIM card that they insert into an existing device. The customer may purchase credit with the cellular provider, such as by purchasing a pre-paid card with a third-party vendor that allows for credit to be applied to a pre-paid account. A customer may purchase multiple pre-paid SIM cards that are inserted into an existing device, such as where a first SIM card is used for voice access and a second SIM card is used for data access. Where multiple SIM cards are used the SIM cards may be provided service by different cellular providers. The embodiments may be relevant to any context in which a cellular provider has little or no biographical information about their customer.

Biographical information may cover any information identifying or describing a customer. Biographical information may include the customer's name, identification number (e.g., National Identification Number, Personal Identification Number, Social Security Number, driver's license number), or other identifying information. Biographical information may include personal information such as address, age, birth date, place of birth, gender, race, ethnicity, e-mail address, credit card numbers, telephone number, or other information associated with a customer. Biographical information may include any information relevant to the identification and targeting of customers.

In many cases, some pieces of biographical information, particularly those unique to a customer, may be used to look up other biographical information. For example, if a customer's National Identification Number (NIN) is known, their age, gender, etc. may be retrieved using the NIN as a key. In some cases, a combination of pieces of biographical information may be used to look up other biographical information. For example, multiple people may have the same name, but additional information such as birth date may uniquely identify someone for retrieval of additional biographical information. Where a mobile device is used by a single user, the phone number for the device may comprise a unique identifier sufficient to look up other biographical information.

Elements of biographical information that are shared across multiple people may be useful in targeting customers for offers. For example, knowing a customer's age and gender may empower targeting based on likely tastes in content, such as media and other entertainment, that are particularly prevalent within a demographic. In contrast, knowing biographical information that uniquely identifies a customer may empower targeting based on specifically-known tastes of the customer, such as associating media purchases with a unique identifier for the customer so as to recommend additional media similar to the purchased media. These techniques may be used in combination, such as where a customer is offered both products that match an individual profile and products that are targeted to the customer's demographics.

Biographical information may also be used to customize offers to customers. Price discrimination may be used, in which the same product is offered to different customers at a difference price. For example, customers with lower income may be offered lower prices than customers with higher income. Customers predicted to have a greater interest in a product may be offered higher prices than customers with a lower interest in the product. Customers with a low interest and/or income may be less inclined to purchase a product and therefore require a lower price in order to make the purchase. Customers with a high interest and/or income may be more inclined to purchase a product and therefore willing to make the purchase at a higher price. By performing price discrimination both the advantages of a high price point and a low price point may be realized: a high price may be extracted from highly-interested and high-income consumers while expanding sales via a low price to low-income or low-interest consumers who may not have been willing to purchase at the higher price. This technique may be particularly valuable for offers delivered directly to consumers at individual mobile devices, as consumers may have no expectation of viewing a general price list, in contrast to the consumer experience with a physical retail store or web store.

Cellular providers may have a plurality of products to offer their customers. Products may include physical products, software products, and service products. Physical products may include cellular devices and device accessories. Software products may include mobile applications for installation on a mobile device. Service products may expand or extend a customer's utility with the cellular provide. Service products may include cellular voice packages, cellular data packages, short messages service (SMS) packages, application-specific data packages (e.g., unlimited bandwidth for one or more specific mobile applications), event-specific data packages (e.g., live streaming of media events). Pre-paid customers may be presented with offers to convert to subscription service.

Cellular providers may have a plurality of channels through which offers may be delivered. Offers may be delivered via Unstructured Supplementary Service Data (USSD), a real-time connection protocol enabling two-two text communication between the user of a cellular device and the cellular provider. Offers may be delivered via SMS. Offers may be delivered via voice calls, including automated voice calls. Offers may be delivered via the web, such as may be accessed through a mobile browser on a cellular device. Offers may be delivered via advertisements included with other services, such as social networking services.

As such, cellular providers may be advantaged by performing offer targeting, including the selection of customers for a particular offer, price discrimination, and channel selection. However, cellular providers, particularly where their customers are pre-paid, may not have access to sufficient biographical information to perform offer targeting. Therefore, they may benefit from a third-party partner that can expand their ability to target offers. Further, a third-party partner may provide additional channels and additional products that may be offered to cellular customers. As a result, a cellular provider may experience an enhanced ability to generate offers, target customers, and deliver the offers to their customers.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives consistent with the claimed subject matter.

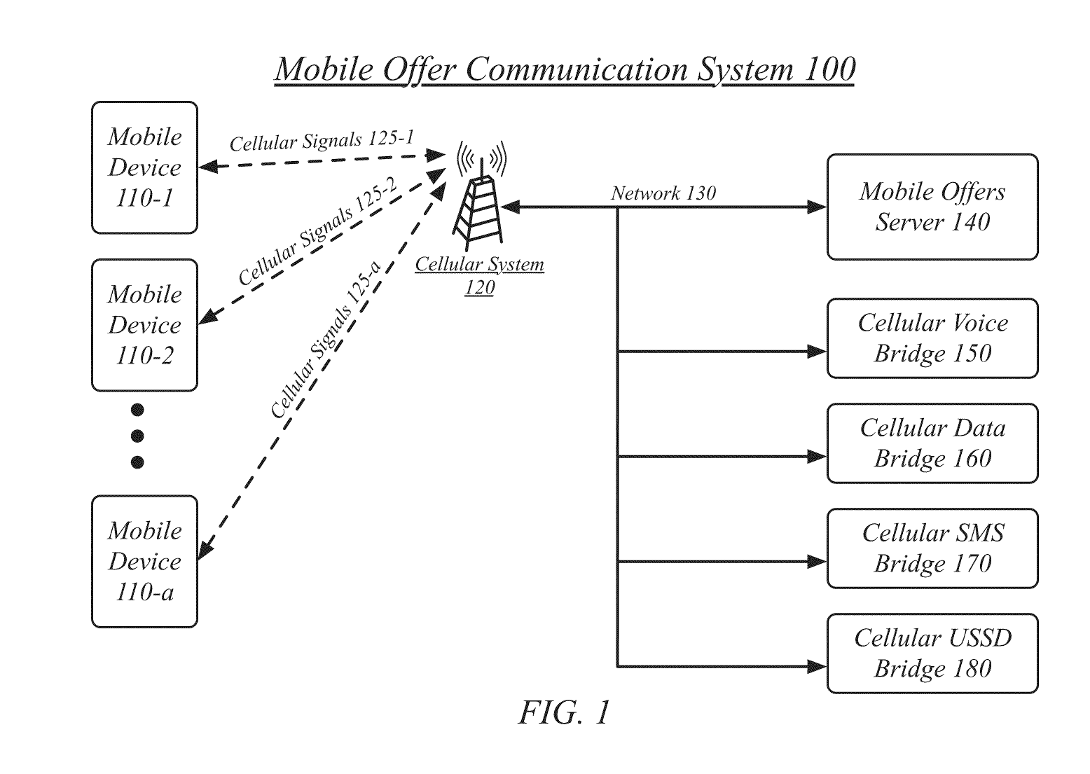

FIG. 1 illustrates a block diagram for a mobile offer communication system 100. In one embodiment, the mobile offer communication system 100 may comprise a computer-implemented system. Although the mobile offer communication system 100 shown in FIG. 1 has a limited number of elements in a certain topology, it may be appreciated that the mobile offer communication system 100 may include more or less elements in alternate topologies as desired for a given implementation.

It is worthy to note that “a” and “b” and “c” and similar designators as used herein are intended to be variables representing any positive integer. Thus, for example, if an implementation sets a value for a=5, then a complete set of components 122 may include components 122-1, 122-2, 122-3, 122-4 and 122-5. The embodiments are not limited in this context.

The mobile offer communication system 100 may be generally arranged to deliver offers to mobile devices 110 for consideration by the users of the mobile devices 110. The mobile offer communication system 100 may determine offers appropriate to a particular user, may determine users appropriate to a particular offer, may determine delivery channels appropriate to a combination of a particular offer and particular user, and may customize an offer to a particular user, such as by performing price discrimination.

Mobile devices 110 may connect to a cellular system 120 use cellular signals 125. Cellular signals 125 may comprise radio transmissions conforming to a cellular standard, such as the Global System for Mobile Communications (GSM). Cellular system 120 may be operated by a cellular provider. Cellular system 120 may be operated by a group of providers, such as where multiple cellular providers each individually pay for access to a plurality of cell sites, reselling the access to their customers.

One or more of mobile devices 110 may be owned and used by customers for which a cellular provider has little or no biographical information suitable for offer targeting. As such, the cellular provider may be benefited by cooperation with a third-party partner that can identify the owner and user of one or more of the mobile devices 110, has access to biographical information of these users, and can use the biographical information to perform offer targeting.

Mobile offers server 140 may manage the selection of one or more mobile devices of the plurality of mobile devices 110 to receive an offer. Mobile offers server 140 may manage the selection of offers for transmission to one or more mobile devices of the plurality of mobile devices 110. Mobile offers server 140 may manage the customization of offers to one or more mobile devices of the plurality of mobile devices 110, such as selecting a price for an offer based on information known about a user of a mobile device of the mobile devices 110.

Multiple delivery channels to the mobile devices 110 may be managed by a cellular provider for the mobile devices 110. A plurality of cellular bridges may be used by the cellular provider for the providing of cellular services. Any of these cellular bridges may be used by the mobile offers server 140 for the communication of offers to mobile devices 110. It will be appreciated that one or more of the mobile offers server 140, cellular voice bridge 150, cellular date data bridge 160, cellular SMS bridge 170, and cellular USSD bridge 180 may be integrated into a single device. For example, a common device may manage voice communication, SMS communication, data communication, and USSD communication for one or more of the mobile devices 110. In some embodiments, multiple mobile offers servers 140 may be used. In some embodiments, multiple mobile offers servers 140 may each be integrated into various other computing devices.

A cellular voice bridge 150 may empower the transmission and reception of voice calls to and from mobile devices 110. Voice calls may be entirely contained within a cellular provider or may connect with outside phones. Cellular voice bridge 150 may be used by mobile offers server 140 to initiate or receive voice calls for the transmission of offers. For example, mobile offers server 140 may contact one or more mobile devices of the plurality of mobile devices 110 with a voice call communicating one or more offers. Mobile offers server 140 may receive a voice call from one or more mobile devices of the plurality of mobile devices 110 requesting to hear offers. An option to receive offers from the mobile offers server 140 may comprise one of a plurality of options on an automated voice menu system. Voice calls may be performed by a human operator based on an offer provided to the human operator by the mobile offers server 140. Voice calls may be performed based on a pre-recorded audio sample initially performed by a human performer. Voice calls may be performed based on computer-generated speech. Any known technique for generating spoken voice may be used for the performance of voice calls. Responses to voice calls, such as the acceptance of an offer, declining of an offer, selection of one or more options related to an offer, or any other interaction with the mobile offers server 140 via the cellular voice bridge 140 may be performed using dual-tone multi-frequency signaling (DTMF, e.g., Touch-Tone), speech recognition, or any other technique for interacting via a voice call with a computer device. Where offers are communicated by a human operator, the human operator may communicate responses into mobile offers server 140 via a computer data-entry interface.

A cellular data bridge 160 may empower the exchange of data communication with mobile devices 110. Data communication may be contained within a cellular provider or may connect with outside devices, such as across the public Internet. Cellular data bridge 160 may be used by mobile offers server 140 to transmit offers to one or more mobile devices of the plurality of mobile devices 110. For instance, mobile offers server 140 may contact one or more of the mobile devices 110 with data traffic containing one or more offers. Mobile offers server 140 may directly communicate with a local application on one or more of the mobile devices 110 for the communication of offers. Mobile offers server 140 may serve content requested by a user that additionally includes advertisements comprising one or more offers. In some embodiments, mobile offers server 140 may communicate with other servers, such as for providing or selecting advertisements for distribution through the web or other data-based content delivery channels. As such, some offer may be received by one or more of the mobile devices 110 as part of network traffic, such as web traffic, received from the Internet via the cellular data bridge 160. Where offers are delivered via a cellular data bridge 160 responses, such as acceptances or selections of options, may be delivered according to a variety of techniques. For instance, an offer may be provided via a local application on a mobile device, the local application empowering a user to respond to an offer. Alternatively, an offer may be provided via a selectable advertisement, with the selection of the advertisement loading a screen, web browser, or other local application empower a user to respond to an offer.

A cellular SMS bridge 170 may empower the transmission and reception of SMS messages to and from mobile devices 110. SMS messages may be contained within a cellular provider or may connect with outside devices, such as across the broader telephone system or the public Internet. Cellular SMS bridge 170 may be used by mobile offers server 140 to transmit offers to one or more mobile devices of the plurality of mobile devices 110. For instance, mobile offers server 140 may contact one or more of the mobile devices 110 with SMS messages containing one or more offers. In some embodiments, users may respond to offers received in SMS messages by sending an SMS message in response, such as a response accepting an offer or selecting options within an offer.

A cellular USSD bridge 180 may empower the exchange of USSD communication with mobile devices 110. A user may engage a USSD mode on a mobile device and enter into a USSD session with the cellular provider. Alternatively, a mobile device may be entered into the USSD session on behalf of the cellular provider, such as to communicate offers to the user. The user may engage the USSD mode in order to receive offers or may engage the USSD mode to perform other operations with the cellular provider and receive the offers in addition to their performance of these operations. Cellular USSD bridge 180 may be used mobile offers server 140 for the communication of one or more offers to one or more mobile devices of the plurality of mobile devices 110 and for the receipt of responses to the one or more offers. Responses to offers received via USSD communication may comprise the acceptance of an offer or the selection of options within an offer.

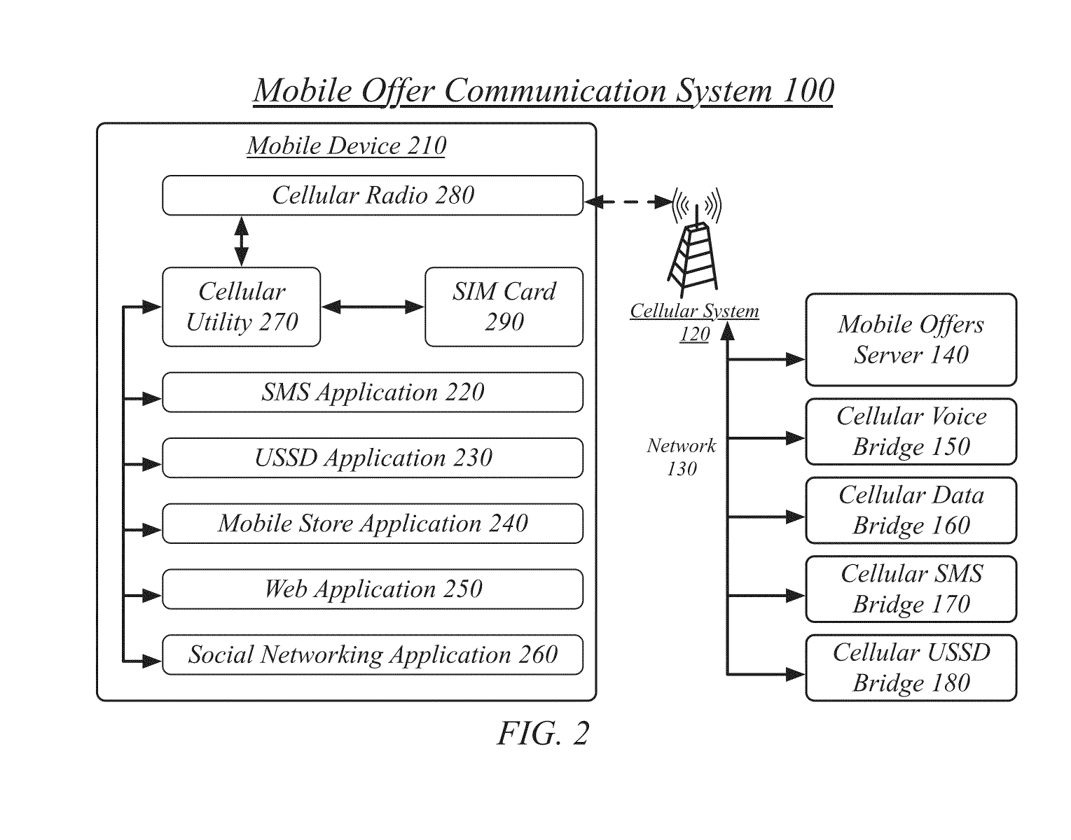

FIG. 2 illustrates a block diagram of a mobile device 210 for use within the mobile offer communication system 100. As illustrated in FIG. 2, mobile device 210 communicates with the mobile offers server 140 via the cellular system 120, such as may be bridged via the cellular voice bridge 150, cellular data bridge 160, cellular SMS bridge 170, and cellular USSD bridge 180.

A mobile device 210 may execute a plurality of applications for interacting with network services. A mobile device 210 may include an SMS application 220, a USSD application 230, a mobile store application 240, a web application 250, and a social networking application 260. The mobile device 210 may include additional applications, one or more of which may also interact with the mobile offers server 140. In some embodiments, additional applications may display advertisements, one or more of which may be selected by the mobile offers server 140 to communicate offers from a cellular provider. One or more of the SMS application 220, USSD application 230, mobile store application 240, web application 250, and social networking application 260 may come pre-installed with the mobile device 210 or may be user-installed, such as by being downloaded from an app repository. One or more of the SMS application 220, USSD application 230, mobile store application 240, web application 250, and social networking application 260 may be utilities integrated with the operating system or other managing software of the mobile device 210 or may be distinct applications run in a user environment provided by an operating system of the mobile device 210.

Exchanging network traffic, such as performing zero-rated network request 165, may comprise transmitting and receiving network traffic via a network interface controller (NIC). A NIC comprises a hardware component connecting a computer device, such as mobile device 210, to a computer network. The NIC may be associated with a software network interface empowering software applications to access and use the NIC. Network traffic may be received over the computer network as signals transmitted over data links. The network traffic may be received by capturing these signals and interpreting them. The NIC may receive network traffic over the computer network and transfer the network traffic to memory storage accessible to software applications using a network interface application programming interface (API).

One or more NICs in a mobile device 210 may include a cellular radio 280. In some embodiments, the mobile device 210 may include multiple radios, such as a radio for Wi-Fi communication, Bluetooth communication, or any other radio-based communication standard. The cellular radio 280 may be accessed via a cellular utility 270 provided by an operating system for network communication by applications on the mobile device 210. The cellular utility 270 may comprise the software network interface for access to the cellular radio 280. Where additional radio and network devices are used with the mobile device 210 additional software network interfaces may be available for access to the radio and network devices. In some embodiments, an operating system of mobile device 210 may manage the selection of a particular network interface for communication, such as by automatically prioritizing a Wi-Fi network interface over a cellular interface where available.

The SMS application 220 may empower a user of mobile device 210 to send and receive SMS messages. The SMS application 220 may communicate over the cellular radio 280 with the cellular system 120 to communicate with the cellular SMS bridge 170 for sending and receiving SMS messages. The SMS application 220 may display offers received from the mobile offers server 140 via SMS message. The SMS application 220 may empower a user to accept an offer and transmit the acceptance of the offer via SMS message. The SMS application 220 may empower a user to select among offer options and transmit an acceptance of the offer along with the selection of options via SMS message. The SMS message accepting an offer may be transmitted to the mobile offers server 140 via the cellular SMS bridge 170.

The USSD application 230 may empower a user of mobile device 210 to exchange USSD communication with a cellular provider. The USSD application 230 may display USSD messages, navigate USSD menus, access USSD services, and make USSD purchases. Purchases made via the USSD application 230 may include offers targeted and customized by the mobile offers server 140. USSD services may include services for messaging with others, accessing network services such as social networking services, and generally any network-based service made accessible by a cellular provider. The USSD application 230 may display offers received from the mobile offers server 140 via USSD communication. The USSD application 230 may empower a user to accept an offer and transmit the acceptance of the offer via USSD communication. The USSD application 230 may empower a user to select among offer options and transmit an acceptance of the offer along with the selection of options via USSD communication. The USSD communication accepting an offer may be transmitted to the mobile offers server 140 via the cellular USSD bridge 180.

The mobile store application 240 may empower a user of mobile device 210 to access a mobile store, some or all of which may be provided by the cellular provider for the mobile device 210. The mobile store application 240 may display offers for hardware, software, and services related to mobile device 210. The offers in the mobile store access by mobile store application 240 may include offers targeted by mobile offers server 140. For example, a mobile store may include a promoted offers section with offers selected as being appropriate to the user of mobile device 210 and customized, such as via price, for the user of mobile device 210. The mobile store application 240 may empower a user to accept an offer and transmit the acceptance of the offer via data communication. The mobile store application 240 may empower a user to select among offer options and transmit an acceptance of the offer along with the selection of options via data communication. The data communication accepting an offer may be transmitted to the mobile offers server 140 via the cellular data bridge 160.

The web application 250 may empower a user of mobile device 210 to receive offers from the mobile offers server 140. The offers may be transmitted via the cellular data bridge 160, with the cellular data bridge 160 generally being used for web access. The offers may be received via a web-based mobile store, such as may be provided by the cellular provider. The offers may be received as part of web communication, such as via inline advertisements, interstitial advertisements, or adjacent advertisements. The web application 250 may be specifically associated with the cellular provider or a third-party partner of the cellular provider, may be provided by a manufacturer of mobile device 210, may be provided by a developed of an operating system for the mobile device 210, or may be an independent web browser. The web application 250 may empower a user to accept an offer and transmit the acceptance of the offer via data communication. The web application 250 may empower a user to select among offer options and transmit an acceptance of the offer along with the selection of options via data communication. The data communication accepting an offer may be transmitted to the mobile offers server 140 via the cellular data bridge 160.

The social networking application 260 may empower a user of mobile device 210 to receive offers from the mobile offers server 140. The offers may be transmitted via the cellular data bridge 160, with the cellular data bridge 160 generally being used for data access by the social networking application 260. The offers may be received as part of social networking communication, such as via inline advertisements, interstitial advertisements, or adjacent advertisements. The social networking application 260 may be specifically associated with a particular social networking service. The social networking application 260 may empower a user to accept an offer and transmit the acceptance of the offer via data communication. The social networking application 260 may empower a user to select among offer options and transmit an acceptance of the offer along with the selection of options via data communication. The data communication accepting an offer may be transmitted to the mobile offers server 140 via the cellular data bridge 160.

The social networking service associated with social networking application 260 may be a third-party partner of the cellular provider. A social networking service may be a valuable partner in that social networking services are well-positioned to gather biographical information about users that may be highly relevant to the targeting of offers, including offer selection, user selection, and offer customization. For example, users often volunteer their name, birth date, place of birth, current address, phone number, gender, race, ethnicity, e-mail address, and other information to a social network service. Similarly, users often register media and other entertainment preferences with a social networking service, such as by associating themselves with a favorite sports team, favorite musicians, favorite bands, favorite music genres, etc.

Further, even where a user doesn't explicitly inform the social networking service as to their biographical information and preferences, biographical information and other relevant information may be inferred based on their interactions on the social networking service. For example, a user may use a social networking service to message a friend about a band they like, a sports team they follow, or other indicators of preference. A user may use a social networking service to receive location-based recommendations, which may entail informing the social networking service as to their current location.

A social networking service may have a user's financial information registered with it, which may be utilized for making purchases with the cellular provider. For example, a user may purchase games or game tokens with a social networking service, buy gifts for friends, or make other purchases with a social networking service. This may entail registering a credit card or other financial instrument with the social networking service. The social networking service may, with the user's permission, use this financial information to perform purchases for offers from the cellular provider.

In addition to the wide variety of information that may be available to them, social networking services may be ideal third-party partners for cellular providers due to the tendency of users to configure their mobile devices for access to social networking services. A user may install the social networking application 260 on their mobile device 210. Alternatively or additionally, they may configure the mobile device 210 for access to the social networking service through a mobile web browser on the mobile device 210. Similarly, they may configure the mobile device 210 for access to the social networking service by registering a phone number with the social networking service, using voice communication and/or SMS messaging to communicate with the social networking service. For example, the user may receive social networking update via SMS messages sent to mobile device 210 and the social networking service may be operative to extent this SMS communication to include the exchange of offers and offer responses on behalf of the cellular provider.

A third-party partner, such as a social networking service, may also have access to a cellular customer even when that cellular customer is not using the cellular system 120 for communication. For example, the mobile device 210 may use Wi-Fi networks when available, divorcing much of their communication from the cellular system 120. The third-party partner, however, may still have access to the customer through data communication, such as on the World Wide Web or through dedicated communication with a social networking service.

In particular embodiments, a user may be an individual (human user), an entity (e.g., an enterprise, business, or third-party application), or a group (e.g., of individuals or entities) that interacts or communicates with or over a social-networking system. In particular embodiments, a social-networking system may be a network-addressable computing system hosting an online social network. The social-networking system may generate, store, receive, and send social-networking data, such as, for example, user-profile data, concept-profile data, social-graph information, or other suitable data related to the online social network. The social-networking system may be accessed by the other components of network 130 either directly or via the public Internet. In particular embodiments, the social-networking system may include an authorization server (or other suitable component(s)) that allows users to opt in to or opt out of having their actions logged by the social-networking system or shared with other systems (e.g., third-party systems such as the cellular provider), for example, by setting appropriate privacy settings. A privacy setting of a user may determine what information associated with the user may be logged, how information associated with the user may be logged, when information associated with the user may be logged, who may log information associated with the user, whom information associated with the user may be shared with, and for what purposes information associated with the user may be logged or shared. Authorization servers may be used to enforce one or more privacy settings of the users of the social-networking system through blocking, data hashing, anonymization, or other suitable techniques as appropriate.

Targeting criteria used to identify and target users may include explicit, stated user interests on the social-networking system or explicit connections of a user to a node, object, entity, brand, or page on a social-networking system. In addition or as an alternative, such targeting criteria may include implicit or inferred user interests or connections (which may include analyzing a user's history, demographic, social or other activities, friends' social or other activities, subscriptions, or any of the preceding of other users similar to the user (based, e.g., on shared interests, connections, or events)). Particular embodiments may utilize platform targeting, which may involve platform and “like” impression data; contextual signals (e.g., “Who is viewing now or has viewed recently the page for COCA-COLA?”); light-weight connections (e.g., “check-ins”); connection lookalikes; fans; extracted keywords; EMU advertising; inferential advertising; coefficients, affinities, or other social-graph information; friends-of-friends connections; pinning or boosting; deals; polls; household income, social clusters or groups; products detected in images or other media; social- or open-graph edge types; geo-prediction; views of profile or pages; status updates or other user posts (analysis of which may involve natural-language processing or keyword extraction); events information; or collaborative filtering. Identifying and targeting users may also include privacy settings (such as user opt-outs), data hashing, or data anonymization, as appropriate.

In particular embodiments, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page to identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example and not by way of limitation, a particular concept node corresponding to a particular photo may have a privacy setting specifying that the photo may only be accessed by users tagged in the photo and their friends. In particular embodiments, privacy settings may allow users to opt in or opt out of having their actions logged by social-networking system or shared with other systems (e.g., a third-party system such as the cellular provider). In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites, advertisers), other suitable users or entities, or any combination thereof. Denial of access may include denial of access for indirect usage, such as for targeting wherein the private information in question is never shared or where it is only implicitly shared such as, for example and without limitation, by virtue of a user being targeted. Although this disclosure describes using particular privacy settings in a particular manner, this disclosure contemplates using any suitable privacy settings in any suitable manner.

In particular embodiments, one or more servers may be authorization/privacy servers for enforcing privacy settings. In response to a request from a user (or other entity) for a particular object stored in a data store, the social-networking system may send a request to the data store for the object. In some instances, a request for a particular object may comprise a request for users matching a particularly criteria. The request may identify the user associated with the request and may only be sent to the user (or a client system of the user) if the authorization server determines that the user is authorized to access the object based on the privacy settings associated with the object. If the requesting user is not authorized to access the object, the authorization server may prevent the requested object from being retrieved or referenced from the data store, or may prevent the requested object from be sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

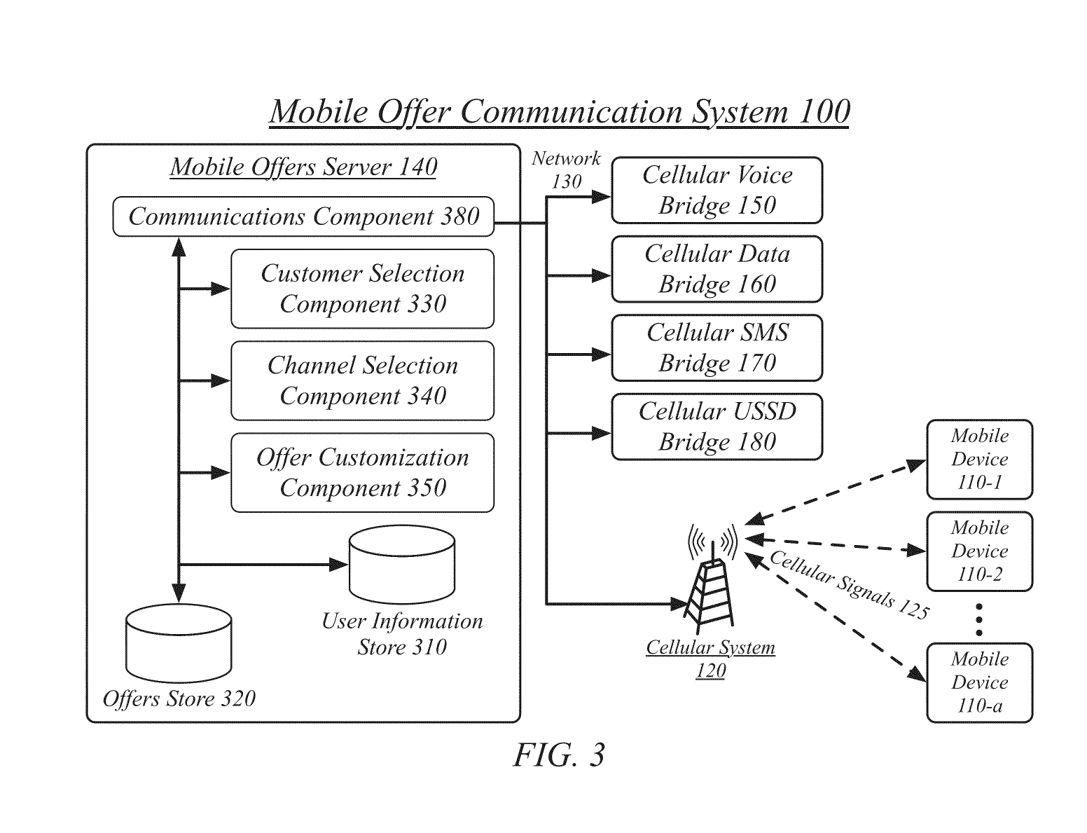

FIG. 3 illustrates a block diagram of the mobile offers server 140 for use within the mobile offer communication system 100. As illustrated in FIG. 3, mobile offers server 140 communicates with a plurality of mobile devices 110 via the cellular system 120, such as may be bridged via the cellular voice bridge 150, cellular data bridge 160, cellular SMS bridge 170, and cellular USSD bridge 180.

The mobile offers server 140 may comprise a plurality of component for the targeting of cellular customers. The mobile offers server 140 may comprise a customer selection component 330, a channel selection component 340, and an offer customization component 350. The mobile offers server 140 may be generally operative to receive offers from a cellular provider and target the offers to particular users and delivery channels based on known information about cellular customers. The components of the mobile offers server 140, such as the customer selection component 330, channel selection component 340, and offer customization component 350 may, in some embodiment, be implemented on different server devices from each other. The components of the mobile offers server 140, such as the customer selection component 330, channel selection component 340, and offer customization component 350, may perform additional tasks to those described herein.

The mobile offers server 140 may comprise a plurality of data stores for the targeting of cellular customers. The mobile offers server 140 may comprise a user information store 310 and an offers store 320. The mobile offers server 140 may be generally operative to use information stored in the user information store 310 in offer targeting, including the selection of offers, selection of customers, selection of delivery channels, and customization of offers.

In some embodiments, one or both of the data stores may be local to the mobile offers server 140, such as a local database or other file store for the mobile offers server 140. In other embodiments, one or both of the data stores may be remotely accessed by the mobile offers server 140, such as where one or both of the data stores are in a network-accessible database or other network-accessible file store. Where one or both of the data stores are remotely accessed a local cache, local index, or other local storage may be used to improve access to the remote store. For example, the user information store 310 may be a network-accessible store for a social networking service, wherein queries may be performed on and against the user information store 310 for offer targeting.

The mobile offers server 140 may receive a plurality of offers from a cellular provider and store the plurality of offers in the offers store 320. Each of the plurality of offers may include an identifier uniquely identifying the offer for a particular cellular provider. Each of the plurality of offers may include descriptive information, such as text and images, for explaining and promoting an offer to a customer. Each of the plurality of offers may include additional information for one or more of customer selection, channel selection, price selection, and other offer customization.

The mobile offers server 140 may receive customer information from a cellular provider and store the customer information. In some embodiments, the customer information may be stored in the user information store 310. The customer information may include the phone number of each customer and customers may be identified by the mobile offers server 140 according to their phone number. For instance, the user information store 310 may store user information for a plurality of users of a third-party service, such as a social networking service. The received phone numbers may be matched against the phone numbers stored in the user information store 310 to determine the users of the third-party service that are also customers of the cellular provider. Each mobile device provided service by a cellular provider may have a SIM card with an associated Mobile Subscriber Integrated Services Digital Network (MSISDN) number used by the cellular provider to identify the mobile devices. The MSISDN number may be provided to the mobile offers server 140 with the phone number so as to allow identification of mobile devices with the cellular provider.

The mobile offers server 140 may be operative to perform purchases with the cellular provider. The mobile offers server 140 may identify the mobile device receiving the benefit of a purchase according to the MSISDN. The cellular provider may make an application programming interface (API) available to the mobile offers server 140 for the performance of purchases on behalf of users. The API may receive, among other inputs, the MSISDN for the identification of mobile devices.

Information stored in the user information store 310 may be used for auto-completion of fields used in the performance of purchases. For example, switching from pre-paid service to subscription service may require the registration of a credit card, an address, and/or other user information. This user information may be known to the mobile offers server 140 via the user information store 310 but not to the cellular provider. The information stored in the user information store 310 may therefore be used to provide the information rather than requiring a user to enter information already available to the mobile offers server 140.

In some cases, a user may have multiple SIMs in their phone, each registered with different cellular providers. A user may be interested in switching between cellular providers, but hesitant due to the work required in transitioning to a new phone number. The information stored in the user information store 310 may be used to ease the process of switching SIMs, and potentially therefore switching cellular providers. For instance, a different SIM may be associated with a different phone number which a user would need to communicate to their friends in order to maintain contact with them. The information stored in the user information store 310 may contain a listing of friends for a user and make it possible for the mobile offers server 140 to have information disseminated to a user's friends. For example, a user may have their friends registered with a social networking service with the mobile offers server 140 generally arranged to communicate a new phone number for a user to the user's friends registered with the social networking service.

The mobile offers server 140 may promote switching SIMs and/or cellular providers by offering to update the user's friends with the user's new phone number. Further, the mobile offers server 140 may generate an offers for free or reduced-priced voice, SMS, or other service elements for users switching to the cellular provider. In some cases, a user may use different SIMs for different services, such as using one SIM for voice and SMS and another SIM for data. The cellular provider associated with the data SIM may offer a voice and/or SMS promotion for switching their mobile device's voice and/or SMS service. Similarly, the cellular provider associated with the voice and/or SMS SIM may offer a data promotion for switching their mobile device's data service. In general, any sort of promotion may be offered to encourage a switch for any element of service to a particular cellular provider.

The customer selection component 330 may be generally arranged to receive an offer and to select one or more customers of a cellular provider for targeting with the retrieved offer. The customer selection component 330 may iteratively receive a plurality of offers and iteratively determine customers for targeting with the received plurality of offers. The offer or offers may be retrieved from the offers store 320. The customer selection component 330 may select the one or more customers based on information known about the customers stored in the user information store 310.

Each of a plurality of offers may include customer selection information for use with the user information known about cellular customers to perform customer selection. An offer may be associated with one or more attribute requirements corresponding to attributes that may be known about a customer in the user information store 310. Attribute requirements may specify a geographic area, age range, gender, or other piece of information about a customer. Attribute requirements may be specified as exclusive (in which any selected customer must possess that attribute to be selected) or inclusive (in which any customer possess that attribute should be selected). In general, requirements for attributes may be combined according to any known technique to create joint requirements of any possible complexity. Given the attribute requirements by a cellular provider, the customer selection component 330 may perform one or more queries against the user information store 310 to determine one or more users associated with the cellular provider that satisfying the attribute requirements. The determined one or more users may comprise the users selected by the customer selection component 330 for reception of an offer.

In some cases, interest-specific information known about users stored in the user information store 310 may be used to select users for receiving an offer. For example, the user information store 310 may contain information as to which users have expressed an enjoyment of a particular interest, such as type of media, type of sport, sports team, performer, band, or other entertainment property or area of media consumption. An offer may specify that the offer should be transmitted to users having expressed their association with the interest. The customer selection component 330 may perform a query against the user information store 310 to determine what users have a registered association with the interest and include those users in the customers selected for receiving an offer.

Automated improvement, automated expansion, or machine learning may be used to determine one or more users for reception of an offer. These may comprise additional users for reception of the offer or may comprise an entirety of the users for reception of the offer. A variety of machine learning techniques may be used to determine users for reception of an offer according to any of the known technique for machine learning.

Given attribute requirements for an offer, an initial group of users may be selected that satisfying the received attribute requirements. An additional group of users may then be selected to expand the pool of users receiving the offer. This additional group of users may be selected based on machine learning applied to the responses received to the offers sent to the initial group of users.

Response data may be accumulated regarding which users from the initial group of users accepted or otherwise responded positively to an offer. Attributes associated with accepting users may be analyzed to determine whether any of the attributes predict acceptance of the offer at greater significance than random chance. Any of the known techniques for filtering attributes for relevance may be used. Attributes not used in the attribute requirements may be of particular interest as being particularly fruitful for expanding the pool of users transmitted the offer. Users matching the additional attributes determined using machine learning may therefore be selected to receive the offer by the customer selection component 330.

A broader form of machine learning may be used to determine users to receive an offer. The customer selection component 330 may generate a representative sample of users based on the user information store 310, wherein the representative sample comprises a subset of the customers of the cellular provider that collectively match the demographics of the complete customer base of the cellular provider. In some cases, a partially-representative sample may be generated that collectively matches a subset of the demographics of the complete customer base of the cellular provider, such as where an offer is still limited to a particular geographic area or other attribute due to limitations on an offer proscribed by the cellular provider—for example, a particular device only being available in a particular area—or established limits on relevance—for example, market research indicating that a particular media event is only relevant to a particular portion of the market.

The offer may be transmitted to the generated sample group of users. Response data may be accumulated regarding which users from the sample accepted or otherwise responded positively to an offer. Attributes associated with accepting users may be analyzed to determine whether any of the attributes predict acceptance of the offer at greater significance than random chance. Users matching these attributes determined using machine learning may be selected to receive the offer by the customer selection component 330.

In some cases, a sample may be generated by a cellular provider providing rules for the performance of A/B testing. The cellular provider may provide two or more sets of attribute requirements to the mobile offers server 140. A sample group of users may be selected for each of the two or more sets of attribute requirements by the customer selection component 330 using the user information store 310. The sample groups may not include every user satisfying the attribute requirements but rather a subset of satisfying users so as to reach a particular sample size. The sample size may be specified by the cellular provider or may be determined automatically based on, for example, techniques for determining sample size given the total population of users, which may correspond to the total number of customers of the cellular provider or the number of customers of the cellular provider for which the mobile offer communication system 100 can perform targeting of offers. Each of the two more sample groups of users may be transmitted the offer and allowed a response period to respond to the offer. Response data may be accumulated regarding which sample group of users responded most favorably to the offer as according to acceptance of the offer. In some cases, the attribute requirements producing the highest acceptance rate may be selected for use on a larger population of cellular customers, such as the general user base of the cellular provider. In other cases, more than one set of attribute requirements may be selected for use, such as where a minimum threshold success rate is specified by the cellular provider, with every set of attribute requirements producing that minimum threshold success rate being used with the general user base of the cellular provider.

In some cases, the sample groups may be allowed to overlap (contain common members) and in some cases the sample groups may be prevented from overlapping. Where the sample groups are allowed to overlap a user in more than one group accepting an offer may count towards the positive performance of every set of attribute requirements producing a sample group containing that user.

In some cases, testing may be performed on a set of attribute requirements without comparison to another set of attribute requirements. A sample group of users may be generated based on the attribute requirements and the user information store 310 and transmitted the offer. A success rate may be determined for the attribute requirements within the sample group. The success rate may be reported back to the cellular provider. Alternatively or additionally, the offer may automatically be transmitted to customers matching the attribute requirements from the full population of cellular customers if the sample group produced a success rate meeting at least a minimum threshold.

The channel selection component 340 may be generally arranged to receive an offer and to select one or more delivery channels for communicating the offer. The channel selection component 340 may iteratively receive a plurality of offers and iteratively determine delivery channels for communicating the received plurality of offers. The channel selection component 340 may select the one or more delivery channels based on information stored in the user information store 310.

The channel selection component 340 may retrieve the offer or offers from the offers store 320 or may receive the offer or offers from the customer selection component 330 after one or more customers have been selected for receiving the offer or offers. Where the customer selection component 330 has selected customers for the offer or offers the selected customers may be received by the channel selection component 340 directly from the customer selection component 330 or through an intermediary such as the offers store 320. The channel selection component 340 may select the one or more delivery channels based on information stored in the user information store 310 about the one or more customers selected by the customer selection component 330.

Each of a plurality of offers may include delivery channel selection information for use in performing delivery channel selection. An offer may be associated with one or more delivery channels specified by the cellular provider for use in communicating the offer to customers. Delivery channels may be selected such that every selected delivery channel available for each selected customer is used for delivering an offer.

Different customers may have different delivery channels available for contacting them. For example, some users may not be equipped to receive SMS messages. Some users may not use a web application 250 or social networking application 260 able to display offers as advertisements. As such, where multiple delivery channels are selected for an offer, only those delivery channels available for each selected customer may be used. Further, in some cases, delivery channels may be ranked such that only the highest-ranked delivery channel available for each selected customer is used for delivering an offer.

Machine learning may be used to determine one or more delivery channels for transmission of an offer. A variety of machine learning techniques may be used to determine delivery channels for reception of an offer according to any of the known technique for machine learning. The channel selection component 340 may generate a representative sample of users based on the user information store 310, wherein the representative sample comprises a subset of the customers of the cellular provider that collectively match the demographics of the complete customer base of the cellular provider. The channel selection component 340 may generate a representative sample of users within the customers selected by the customer selection component 330, wherein the representative sample comprises a subset of the customers of the cellular provider that collectively match the demographics of the customers selected by the customer selection component 330.

The offer may be transmitted to the generated sample group of users on a plurality of delivery channels and allowed a response period to respond to the offer. Alternatively, a sample group of users may be selected for each delivery channel with each sample group receiving the offer on their associated delivery channel and allowed a response period to respond to the offer. Response data may be accumulated regarding the success rate for each delivery channel in generating positive responses to an offer.

In some cases, the delivery channel producing the highest acceptance rate may be selected for use on a larger population of cellular customers, such as the general user base of the cellular provider or the full set of customers selected by the customer selection component 330. In other cases, more than one delivery channel may be selected for use, such as where a minimum threshold success rate is specified by the cellular provider, with every delivery channel producing that minimum threshold success rate being used with the general user base of the cellular provider or the full set of customers selected by the customer selection component 330. Alternatively, the delivery channel may be ranked according to their success rate, with each or the full set of customers selected by the customer selection component 330 being transmitted the offer on the highest-ranked delivery channel available for that customer.

The offer customization component 350 may be generally arranged to receive an offer and to customize the offer. The offer customization component 350 may iteratively receive a plurality of offers and iteratively determine one or more customizations for the received plurality of offers. The offer customization component 350 may determine the one or more customizations based on information stored in the user information store 310. Offer customization may include, without limitation, price selection, price adjustment, and customization of offer presentation such as offer language and one or more images associated with the offer presentation.

The offer customization component 350 may retrieve the offer or offers from the offers store 320, may receive the offer or offers from the customer selection component 330 after one or more customers have been selected for receiving the offer or offers, or may receive the offer or offers from the channel selection component 340 after one or more delivery channels have been selected for communicating the offer or offers. Where the offer customization component 350 has selected customers for the offer or offers the selected customers may be received by the offer customization component 350 directly from the customer selection component 330, may be received by the offer customization component 350 from the channel selection component 340, or through another intermediary such as the offers store 320. The offer customization component 350 may select the one or more customizations based on information stored in the user information store 310 about the one or more customers selected by the customer selection component 330.

Each of the plurality of offers may include a price determined by the cellular provider. Each of the plurality of offers may include a selectable flag indicating whether or not price discrimination may be performed by the mobile offer communication system 100 based on the known user information. One or more of the plurality of offers may have the selectable flag for price discrimination selected such that price discrimination may be performed for the one or more of the plurality of offers based on the known user information. Alternatively, one or more of a plurality of offers may not include a price, with the mobile offers server 140 determining the price entirely according to machine learning.

Machine learning may be used to determine one or more prices an offer is made available at. A variety of machine learning techniques may be used to determine the prices or prices of an offer according to any of the known technique for machine learning. In some cases, machine learning may be used to determine a single price that the offer will be presented at for all customers. In other cases, machine learning may be used to determine a plurality of prices, wherein each price is associated with a particular market segment in order to perform price discrimination.

The offer customization component 350 may generate a representative sample of users based on the user information store 310, wherein the representative sample comprises a subset of the customers of the cellular provider that collectively match the demographics of the complete customer base of the cellular provider. The offer customization component 350 may generate a representative sample of users within the customers selected by the customer selection component 330, wherein the representative sample comprises a subset of the customers of the cellular provider that collectively match the demographics of the customers selected by the customer selection component 330.

The offer may be transmitted to the generated sample group of users at a plurality of prices. The plurality of prices may be specified by the cellular provider or generated by the offer customization component 350. Response data may be accumulated regarding which users from the sample accepted or otherwise responded positively to an offer. Attributes associated with accepting users may be analyzed to determine whether any of the attributes predict acceptance of the offer at a particular price at greater significance than random chance. The offer may be transmitted to the generated sample group of users according to delivery channels selected by the channel selection component 340.

Each price for an offer may therefore have associated with it prediction information indicating, given a particular set of attributes, the probability of a user accepting the offer at that price. For a given user, therefore, it may be predicted for each tested price the probability of that user accepting the offer. This prediction information may be used to determine the price or prices of the offer. Alternatively, the prediction information may not distinguish based on attributes and may reflect the probability of a random user accepting the offer at each price.

Where a single price is determined, a price generating a maximum predicted revenue or maximum predicted profit may be determined. The maximum predicted revenue may be generated according to the total revenue predicted across all of the customers receiving the offer, equal to the total sum of the single price multiplied by the probability of each customer or each customer selected by the customer selection component 330 accepting the offer. The maximum predicted profit may be generated according to the total profit predicted across all of the customers receiving the offer, equal to the total sum of the single price minus the cost of delivering on the offer multiplied by the probability of each customer or each customer selected by the customer selection component 330 accepting the offer.

Where multiple prices are determined, attributes dividing the total group of selected customers may be determined as well as the multiple prices. In other cases, the multiple prices may be specified by the cellular provider, with the attributes determined according to machine learning. In further cases, both the plurality of prices and the attribute for distinguishing between them may be specified by the cellular provider. The attributes may be selected so as to generate a maximum predicted revenue or a maximum predicted profit.

Machine learning performed by the customer selection component 330, channel selection component 340, and/or offer customization component 350 may be performed independently or jointly. Each component may determine the customer group, delivery channels, and customization options iteratively, with tests performed in stages. Alternatively, testing may be performed in a group, wherein tests to determine, for example, attributes for customer selection, delivery channel ranking, and price discrimination are performed simultaneously and, potentially, using the same groups of users.

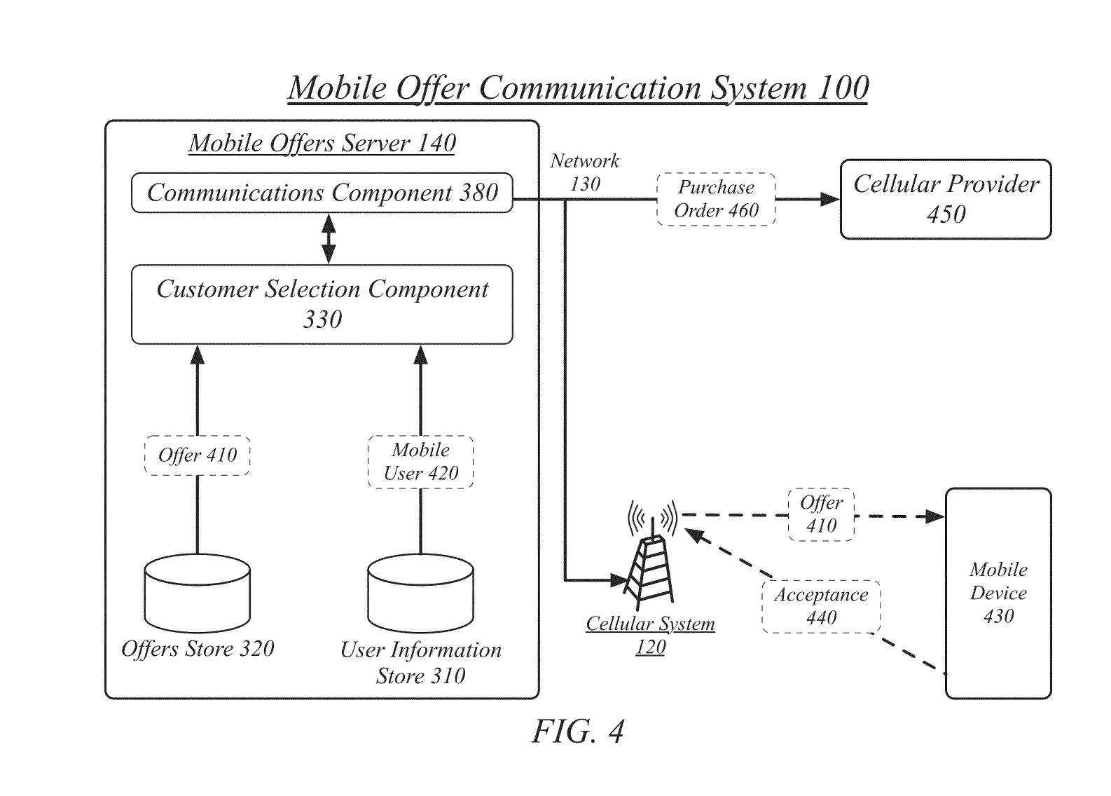

FIG. 4 illustrates an embodiment of the mobile offers server 140 selecting a mobile user to receive an offer 410. As illustrated in FIG. 4, the mobile offers server 140 transmits an offer 410 to a mobile device 430, the mobile device 430 associated with a particular mobile user.

The mobile offers server 140 may receive offer information from a cellular provider 450. The offer information may comprise a plurality of offers, wherein each of the plurality of offers is identified by an offer identifier. The mobile offers server 140 may store the offer information in an offers store 320. The mobile offers server 140 may intermittently or periodically receive additional offer information and update the offers store 320 according to the additional offer information, which may include adding additional offers and removing or modifying existing offers.

The customer selection component 330 may be operative to retrieve an offer 410 of a plurality of offers from an offers store 320, the offer 410 associated with an offer identifier, the offer 410 associated with offer selection criteria. The offer 410 may be for a product offered by a cellular provider 450 to its mobile customers. The offer 410 may comprise at least one of a cellular voice package, a cellular data package, a short message service package, an application-specific data package, an event-specific data package, a cellular device, a cellular device accessory, and an offer to convert from pre-paid to subscription service. The offer identifier may have been assigned by the cellular provider 450 and may uniquely identify the offer 410 within those offers offered by the cellular provider 450.

The customer selection component 330 may be operative to search a user information store 310 to select a mobile user based on a match between the offer selection criteria and user information for the mobile user stored in the user information store 310. The user information may comprise at least one of demographic information, user interest information, and user connection information for the mobile user derived from a social-networking service of which the mobile user is a member, the mobile user identified as the member of the social-networking service based on a phone number for the mobile device 430 received from the cellular provider 450. The cellular provider 450 may identify its customers to the mobile offer communication system 100 using the phone numbers of the customers, the mobile offers server 140 matching the phone numbers against phone numbers known to the mobile offers server 140 through a distinct source of information, such as the social-networking service.

The customer selection component 330 may be operative to transmit, via a network interface, the offer 410 to a mobile device 430 associated with the mobile user, the mobile device 430 identified by a mobile device identifier, the mobile device associated with a cellular provider 450 for mobile service. The mobile identifier may comprise a MSISDN for the mobile device 430. The network interface may comprise a software network interface to a hardware network interface controller (NIC). The customer selection component 330 transmitting via a networking interface may comprise using a communications component 380 of the mobile offers server 140, the communications component 380 interfacing with the networking interface for an operating system (OS) of the server device executing the mobile offers server 140, the networking interface for the OS controlling the NIC of the server device.

The customer selection component 330 may be operative to receive, via the network interface, an acceptance 440 of the offer 410 from the mobile device 430. The acceptance 440 of the offer 410 may include the selection of options for the offer 410. For example, where the offer 410 offers the purchase of a cellular voice package, the acceptance 440 of the offer 410 may indicate a number of minutes of cellular voice to be purchased.

Where the mobile user is a member of the social-networking service, the social-networking service may be used to inform others of a change in phone service for the mobile user, thereby reducing the friction of changing phone service and increasing the potential willingness of a mobile user to change their phone service. An offer 410 may include activation of a phone number for at least one of cellular voice service or short message service for the mobile device 430 with the cellular provider 450. The offer 410 may promote social-networking notification of the activation of the phone number, such as text, audio, image, or video indicating to the mobile user that their friends on the social-networking service will receive notifications that the mobile user has a new phone number and that the social-networking service will update contact information for the mobile user on the social-networking service to reflect the new phone number. The customer selection component 330 may therefore, in response to the mobile user accepting the offer 410, automatically transmit a notification of an association of the phone number with the mobile user in the social-networking service.

The customer selection component 330 may be operative to transmit, via the network interface, a purchase order 460 to the cellular provider, the purchase order 460 comprising the offer identifier and the mobile device identifier, the purchase order 460 indicating the acceptance 440 of the offer 410 to the cellular provider 450. Where the offer 410 was accepted with specific options, the options selected by the mobile user may be communicated to the cellular provider 450 as part of the purchase order 460. The purchase order 460 may initiate the performance of the offer 410, and its options if any, with the cellular provider 450. The performance of an offer 410 may include the activation of service, the initiation of delivery for physical products, a registration of service to be activated at a future date, or any combination thereof. The performance of an offer 410 may include billing the mobile user for the accepted offer 410, which may comprise the charging of a credit card, debiting from an account for the mobile user with the cellular provider 450, registration of a recurring charge for subscription service, or any other technique for charging a customer a fee. In some embodiments, customer billing may be performed by the mobile offers server 140, such as where a user has registered billing information with a service associated with the mobile offers server 140, such as a social-networking service.

Information known about the mobile user in a social-networking service, or other service comprising independently-developed user information, may be used in the performance of an offer 410. For example, the purchase order 450 may comprise subscriber information for the mobile user, such as where a mobile user is being upgraded from a pre-pay customer to a subscription customer. The mobile offers server 140 may auto-fill the subscriber information for the mobile user based on member information for the member in the social-networking service. This may ease the process of subscribing to subscription cellular service for the user, thereby increasing the likelihood of a mobile user becoming a subscription customer. Further, the social-networking service providing the subscriber information may increase the reliability of the information—increase the probability that the subscriber information is valid based on validation procedures performed by the social-networking service—and thereby reduce the risk to the cellular provider 450 of the subscriber information being invalid or fraudulent. This may, in turn, reduce the financial risk to the cellular provider 450 in offering promotions to the mobile user (e.g., a discounted mobile device) on subscription that are expected to be repaid through subscription fees that are more likely to be received where the mobile user is correctly identified. Similarly, the subscriber information known to the social-networking service may indicate the financial reliability of the mobile user and therefore be useful in selecting which mobile users are appropriate for subscription service.

In some embodiments, machine learning may be used in customer selection. The customer selection component 330 may be operative to select a set of mobile devices for offer testing, transmit the offer 410 to the set of mobile devices, receive acceptances of the offer 410 from at least a portion of the set of mobile devices, perform machine learning to determine offer performance criteria for the offer, and select the mobile user based on the determined offer performance criteria. The offer performance criteria may include at least one of demographic information, user interest information, and user connection information for mobile users derived from a social-networking service of which the mobile users are members.

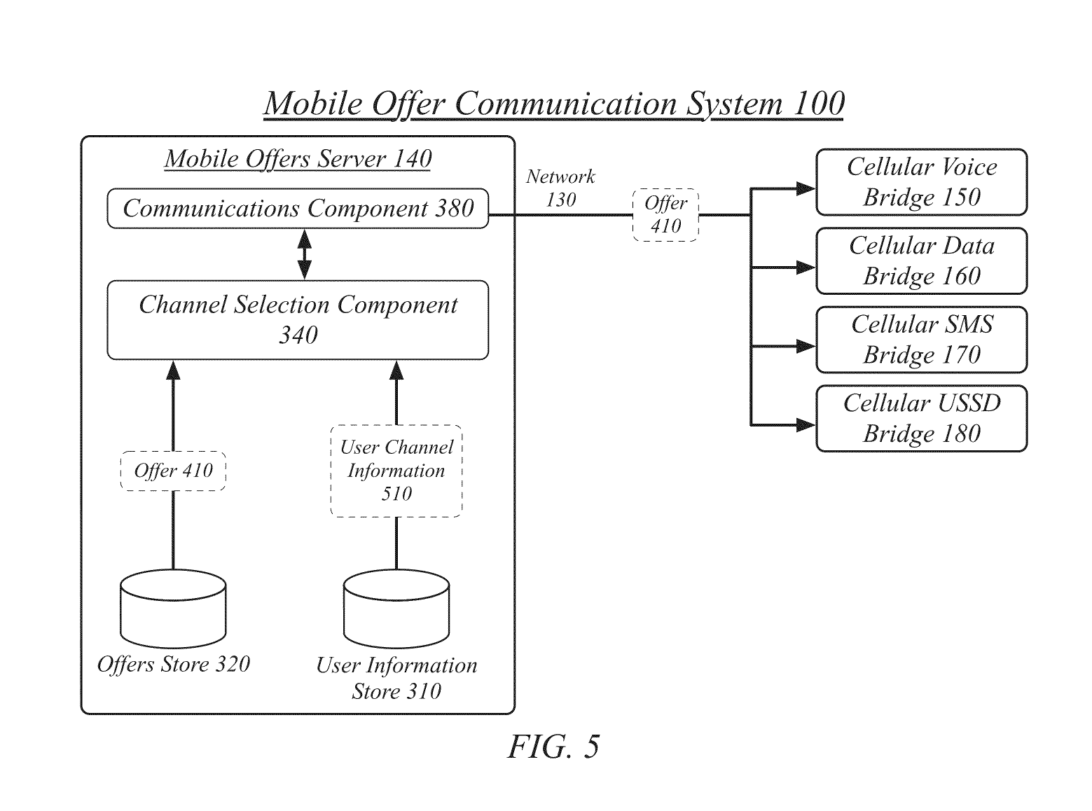

FIG. 5 illustrates an embodiment of the mobile offers server 140 selecting a channel for communicating with a mobile user. As shown in FIG. 5, a plurality of delivery channels are available to the mobile offers server 140 for communication with a mobile device 430 of the mobile user.

The offer 410 may comprise a listing of one or more approved delivery channels. In general, each of the offers in the offers store 320 may comprise approved delivery channels for each of the offers. The approved delivery channels may be assigned by the cellular provider 450 and received as part of the offer information received from the cellular provider 450. In some cases, all available delivery channels may be approved for a particular offer 410. In some embodiments, all available delivery channels may be implicitly approved for all offers through a lack of restriction on the delivery channels that may be used by the mobile offers server 140.

The channel selection component 340 may determine a plurality of available delivery channels for the mobile device 430 based on the user information and the listing of one or more approved delivery channels, the available delivery channels comprising at least two or more of cellular voice, short message service, unstructured supplementary service data, and network-data-based advertisement. The available delivery channels may comprise the overlap between those delivery channels that the mobile device 430 is operative to receive on and the approved delivery channels for the offer 410. This may correspond to the union of the set of approved delivery channels and the set of operative delivery channels for the mobile device 430 or mobile user.

The channel selection component 340 may select a delivery channel from the plurality of available delivery channels based on the user information for the mobile user in the user information store 310. The channel selection component 340 may transmit the offer 410 to the mobile device 430 using the selected delivery channels. Transmitting the offer 410 to the mobile device 430 may comprise using the cellular voice bridge 150, cellular data bridge 160, cellular SMS bridge 170, or cellular USSD bridge 180 for the cellular provider 450.

Use of a cellular bridge may be performed implicitly, with the cellular bridge activated in response to the reception of a communication transmitted by the mobile offers server 140. For instance, network-data-based advertisement may be transmitted using the Transmission Control Protocol/Internet Protocol (TCP/IP) protocol, with the routing of TCP/IP packets eventually reaching the cellular data bridge 160 due to the IP address for the mobile device 430 being associated with delivery beyond the cellular data bridge 180. Similarly, an SMS message may be delivered using a general SMS sender, with the SMS message routed to the cellular SMS bridge 170 due to registration of the mobile device 430 with the cellular SMS bridge 170 of the cellular provider 450 due to the mobile device 430 receiving cellular service from the cellular provider 450. A voice call may be initiated as a standard phone call, with the cellular voice bridge 150 activated as part of a standard routing of the phone call to the cellular voice bridge 150 due to the mobile device 430 being registered with the cellular provider 450 for cellular voice service. In contrast, a cellular USSD bridge 180 may be contacted directly by the mobile offers server 140 for communication with the mobile device 430, with access to the cellular USSD bridge 180 provided as part of the business relationship between an operator of the mobile offers server 140 and the cellular provider 450.

In some embodiments, a network-data-based advertisement may be transmitted to a mobile application on the mobile device 430 via an advertisement delivery channel for the mobile application. A mobile application may be operative to show interstitial advertisements, banner advertisements, inline advertisements, adjacent advertisements, or any other form of advertisement. The mobile application may be operative to show these advertisements as part of its normal operation, the advertisements including both advertisements for the products of the cellular provider 450 and advertisements received from other sources and for products independent of the cellular provider 450 or any cellular provider. The advertisements for the cellular provider 450 selected for the mobile device 430 may enter the pool of advertisements distributed to the mobile device 430 in response to opportunities to show advertisements, the advertisement for the offer 410 sent to the mobile application on the mobile device 430 in response to the determination by the customer selection component 330 that the offer 410 should be transmitted to the mobile device 430 and the determination by the channel selection component 340 that a network-data-based advertisement should be used to communicate the offer 410. In some embodiments, the mobile application may be associated with a social-networking service of which the mobile user is a member, the social-networking service being the same social-networking service as providing user information for the targeting of offers to the mobile user.

In some embodiments, machine learning may be used in delivery channel selection. The channel selection component 340 may be operative to select a set of mobile devices for offer testing, transmit the offer 410 to the set of mobile devices, receive acceptances of the offer 410 from at least a portion of the set of mobile devices, perform machine learning to determine offer performance criteria for the offer, and select the delivery channel based on the determined offer performance criteria. The offer performance criteria may include at least one of demographic information, user interest information, and user connection information for mobile users derived from a social-networking service of which the mobile users are members.

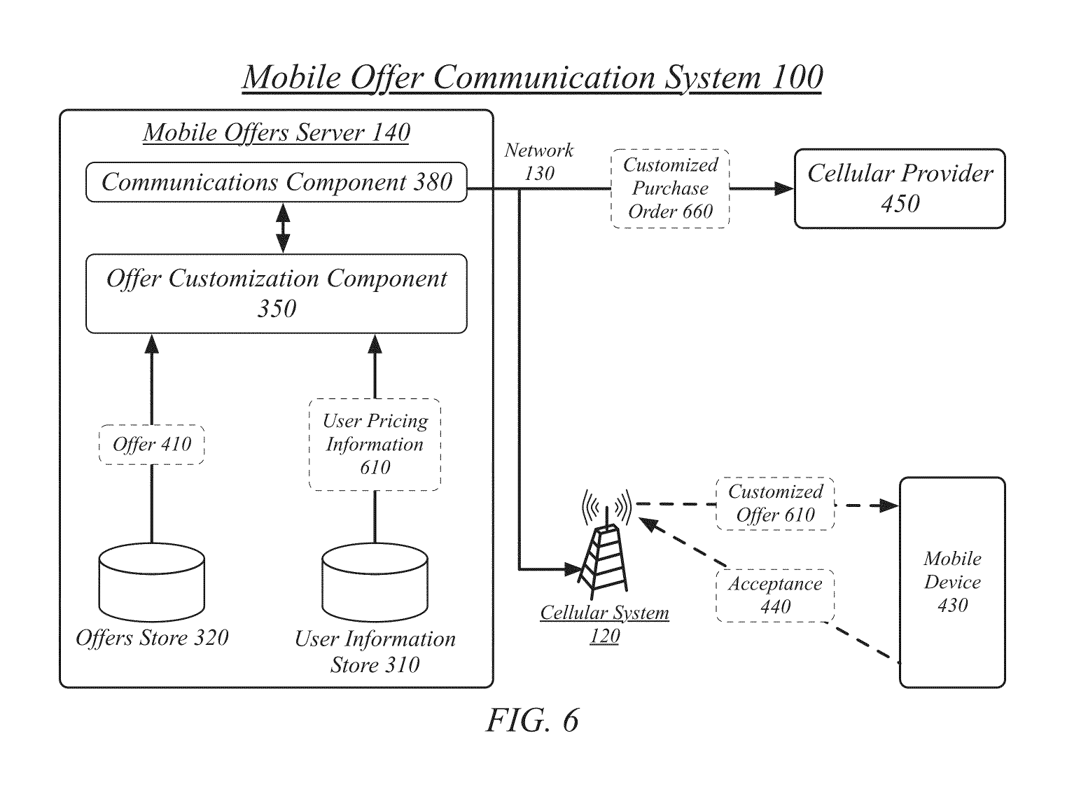

FIG. 6 illustrates an embodiment of the mobile offers server 140 customizing an offer 410 to a mobile user. As shown in FIG. 6, the offer 410 delivered to the mobile device 430 may be a customized offer 610, the customized offer 610 comprising the offer 410 with elements of the offer 410 customized to the mobile user of the mobile device 430.

The cellular provider 450 may specify that elements of an offer 410 may be customized by the mobile offers server 430 to the customers to which it is offered. The cellular provider 450 may authorize the operator of the mobile offers server 430 to set a user-specific price for an offer 410 based on the user information known to the operator for the purpose of extracting a higher price from customers willing to pay a higher price and to expand the reach of a product represented by offer 410 to customers unwilling to pay the higher price but willing to accept the offer 410 at a lower price.

The offer 410 transmitted to the mobile device 430 may therefore comprise a customized offer 610 comprising a user-specific price. It will be appreciated that a price being user-specific may correspond to the particular price used in that customized offer 610 being selected on an individual basis. That same price may also be used for other mobile users—particularly for users with similar demographics, purchasing preferences, financial resources, etc.—so that the user-specific price is not unique to that mobile user. Instead the user-specific price is selected according to specifically known about the individual mobile user.

The purchase order 460 transmitted to the cellular provider 450 may comprise a customized purchase order 660. The customized purchase order 660 may comprise information about how an offer 410 was customized to a particular mobile user. The customized purchase order 660 may comprise the user-specific price offered to the mobile user in the customized offer 610.

The offer customization component 350 may be operative to customize the offer 410 to comprise the user-specific price based on the user information for the mobile user in the user information store 310. The offer 410 specification received from the cellular provider 450 may indicate limits on price customization, such as a maximum or minimum price. The offer 410 specification received from the cellular provider 450 may indicate a minimum average price at which the offer 410 may be made. The offer 410 specification received from the cellular provider 450 may indicate a minimum average target price representing an expectation of an average price that the operator of the mobile offers server 140 is expected to achieve for acceptances of offer 410.

In some embodiments, machine learning may be used in offer customization. The offer customization component 350 may be operative to select a set of mobile devices for offer testing, transmit the offer 410 to the set of mobile devices, receive acceptances of the offer 410 from at least a portion of the set of mobile devices, perform machine learning to determine offer performance criteria for the offer, and customize the offer 410 based on the determined offer performance criteria. The offer performance criteria may include at least one of demographic information, user interest information, and user connection information for mobile users derived from a social-networking service of which the mobile users are members.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

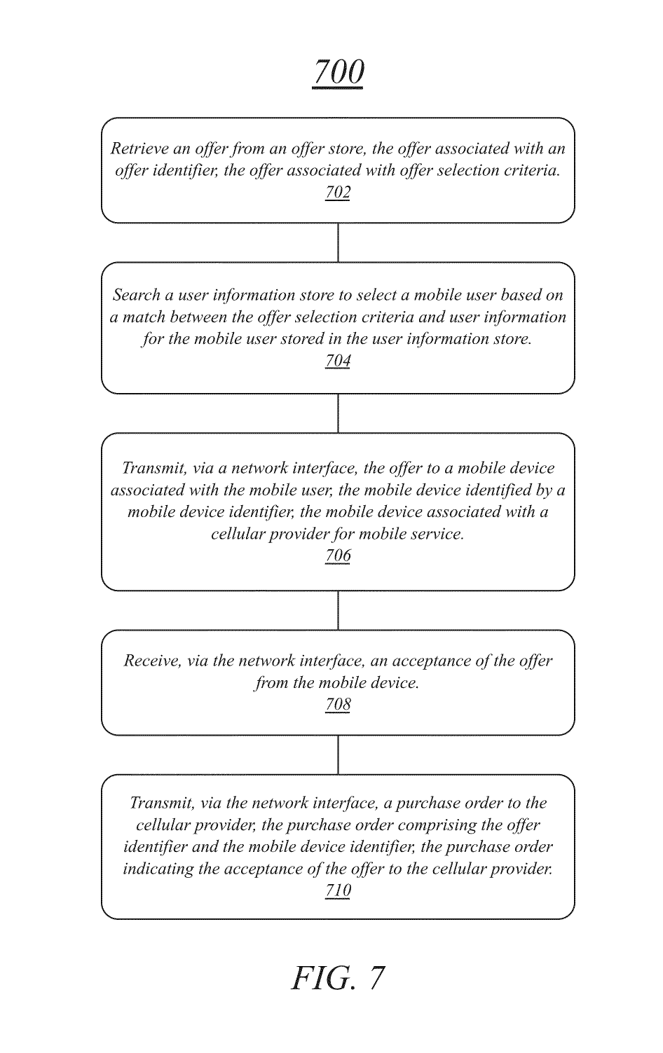

FIG. 7 illustrates one embodiment of a logic flow 700. The logic flow 700 may be representative of some or all of the operations executed by one or more embodiments described herein.

In the illustrated embodiment shown in FIG. 7, the logic flow 700 may retrieve an offer 410 from an offers store 320, the offer 410 associated with an offer identifier, the offer 410 associated with offer selection criteria at block 702. The offer 410 may be retrieved from among a plurality of offers stored in the offers store 320. The plurality of offers may have been received from a cellular provider 450 and stored in the offers store 320 in response to that reception. The offer 410 may comprise at least one of a cellular voice package, a cellular data package, a short message service package, an application-specific data package, an event-specific data package, a cellular device, a cellular device accessory, and an offer to convert from pre-paid to subscription service.

The logic flow 700 may search a user information store to select a mobile user based on a match between the offer selection criteria and user information for the mobile user stored in the user information store at block 704. The user information may comprise at least one of demographic information, user interest information, and user connection information for the mobile user derived from a social-networking service of which the mobile user is a member, the mobile user identified as the member of the social-networking service based on a phone number for the mobile device 430 received from the cellular provider 450.

The logic flow 700 may transmit, via a network interface, the offer 410 to a mobile device 430 associated with the mobile user, the mobile device 430 identified by a mobile device identifier, the mobile device 430 associated with a cellular provider 450 for mobile service at block 706.

Communication with the mobile user may be performed via a delivery channel. An offer 410 may be associated with a listing of one or more approved delivery channels by the cellular provider 450. The logic flow 700 may determine a plurality of available delivery channels for the mobile device 430 based on the user information and the listing of one or more approved delivery channels, the available delivery channels comprising at least two or more of cellular voice, short message service, unstructured supplementary service data, and network-data-based advertisement, select a delivery channel from the plurality of available delivery channels based on the user information for the mobile user in the user information store 310, and transmit the offer to the mobile device 430 using the selected delivery channel. When selected, a network-data-based advertisement may be transmitted to a mobile application on the mobile device 430 via an advertisement delivery channel for the mobile application. In some embodiments, a mobile application may be associated with a social-networking service of which the mobile user is a member.

The logic flow 700 may receive, via the network interface, an acceptance 440 of the offer 410 from the mobile device at block 708.

The offer 410 may include activation of a phone number for at least one of cellular voice service or short message service for the mobile device. Where the mobile user is a member of a social-networking service, the offer may promote social-networking notification of the activation of the phone number. The logic flow 700 may automatically transmit a notification of an association of the phone number with the mobile user in the social-networking service in response to the acceptance 440 of the offer 410 by the mobile user.

The logic flow 700 may transmit, via the network interface, a purchase order to the cellular provider, the purchase order comprising the offer identifier and the mobile device identifier, the purchase order indicating the acceptance of the offer to the cellular provider at block 710.

The purchase order 460 may comprise subscriber information for the mobile user. Where the mobile user is a member of a social-networking service, the logic flow 700 may auto-fill the subscriber information for the mobile user based on member information for the member in the social-networking service. The auto-filling of the subscriber information may be performed in the generation of the purchase order 460. The auto-filling of the subscriber information may be performed on a user-editable form used by the mobile user for application to subscription service. For example, a name field, address field, and other fields may be pre-filled by the logic flow 700 based on the user information known for the mobile user.

Any of mobile user selection, delivery channel selection, or offer customization may be performed with the use of machine learning. The logic flow 700 may select a set of mobile devices for offer testing, transmit the offer 410 to the set of mobile devices, receive acceptances of the offer 410 from at least a portion of the set of mobile devices, perform machine learning to determine offer performance criteria for the offer 410, and select at least one of the mobile user, a delivery channel to the mobile user, and a user-specific price based on the determined offer performance criteria. The machine-learning may be performed based on A/B testing on any of user selection criteria, delivery channel selection criteria, and price selection criteria.

In some embodiments, a user-specific price may be used. The logic flow 700 may be operative to customize the offer 410 to comprise the user-specific price based on the user information for the mobile user in the user information store 310. The logic flow 700 may therefore transmit the offer 410 to the mobile device 430 comprising the user-specific price. The logic flow 700 may transmit the purchase order 460 to the cellular provider 450 comprising the user-specific price.

The embodiments are not limited to this example.

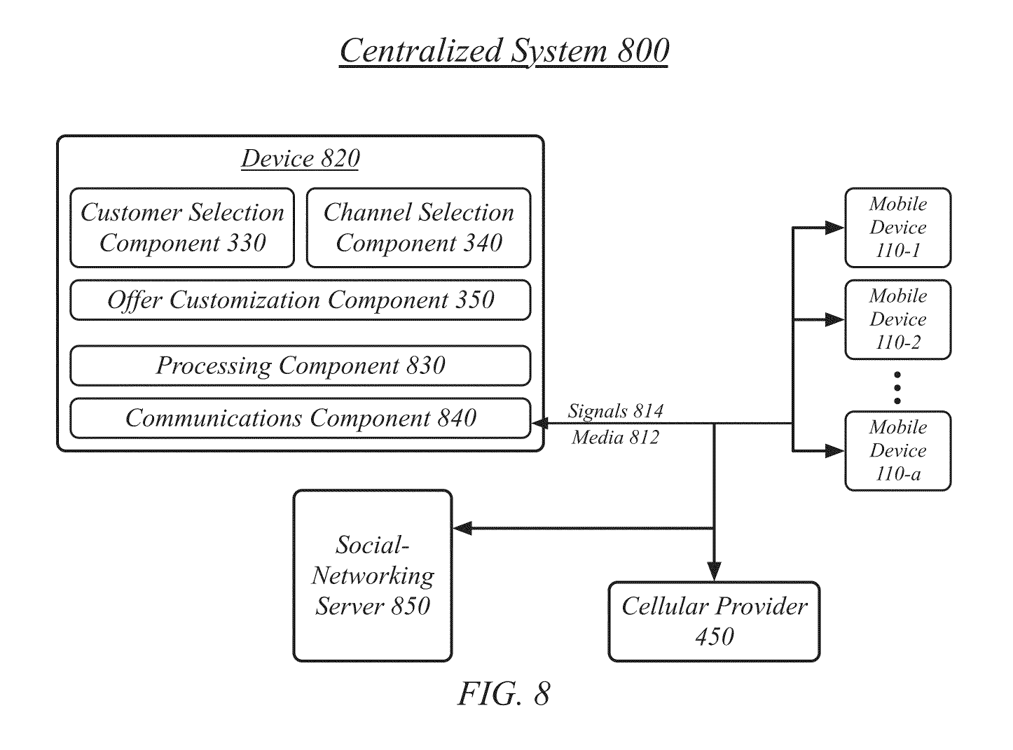

FIG. 8 illustrates a block diagram of a centralized system 800. The centralized system 800 may implement some or all of the structure and/or operations for the mobile offer communication system 100 in a single computing entity, such as entirely within a single device 820.

The device 820 may comprise any electronic device capable of receiving, processing, and sending information for the system 100. Examples of an electronic device may include without limitation an ultra-mobile device, a mobile device, a personal digital assistant (PDA), a mobile computing device, a smart phone, a telephone, a digital telephone, a cellular telephone, ebook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, base station, subscriber station, mobile subscriber center, radio network controller, router, hub, gateway, bridge, switch, machine, or combination thereof. The embodiments are not limited in this context.

The device 820 may execute processing operations or logic for the mobile offer communication system 100 using a processing component 830. The processing component 830 may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The device 820 may execute communications operations or logic for the mobile offer communication system 100 using communications component 840. The communications component 840 may implement any well-known communications techniques and protocols, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The communications component 840 may include various types of standard communication elements, such as one or more communications interfaces, network interfaces, network interface cards (NIC), radios, wireless transmitters/receivers (transceivers), wired and/or wireless communication media, physical connectors, and so forth. By way of example, and not limitation, communication media 812, 842 include wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media.

The device 820 may communicate with other devices over a communications media 812 using communications signals 814 via the communications component 840. The devices may be internal or external to the device 820 as desired for a given implementation. For example, the device 820 may implement the mobile offers server 140 comprising the customer selection component 330, the channel selection component 340, and the offer customization component 350. The device 820 may use communications signals 814 to communicate with the mobile devices 110, the cellular provider 450, and a social-networking server 850.

The social-networking server 850 may comprise a server or one of a plurality of servers maintained by a social-networking service of which a mobile user is a member. The social-networking server 850 may be used for the searching or transmission of user information related to customers of the cellular provider 450. For example, the cellular provider 450 may provide phone numbers for their customers to the mobile offers server 140 and the mobile offers server 140 may request relevant user information from the social-networking server 850, the user information retrieved by identifying users based on their phone number, the user information stored in the user information store 310. Alternatively, the user information store 310 may be maintained by the social-networking server 850 with user information for various mobile users retrieved on-demand from the social-networking server 850 during the operation of the mobile offers server 140.

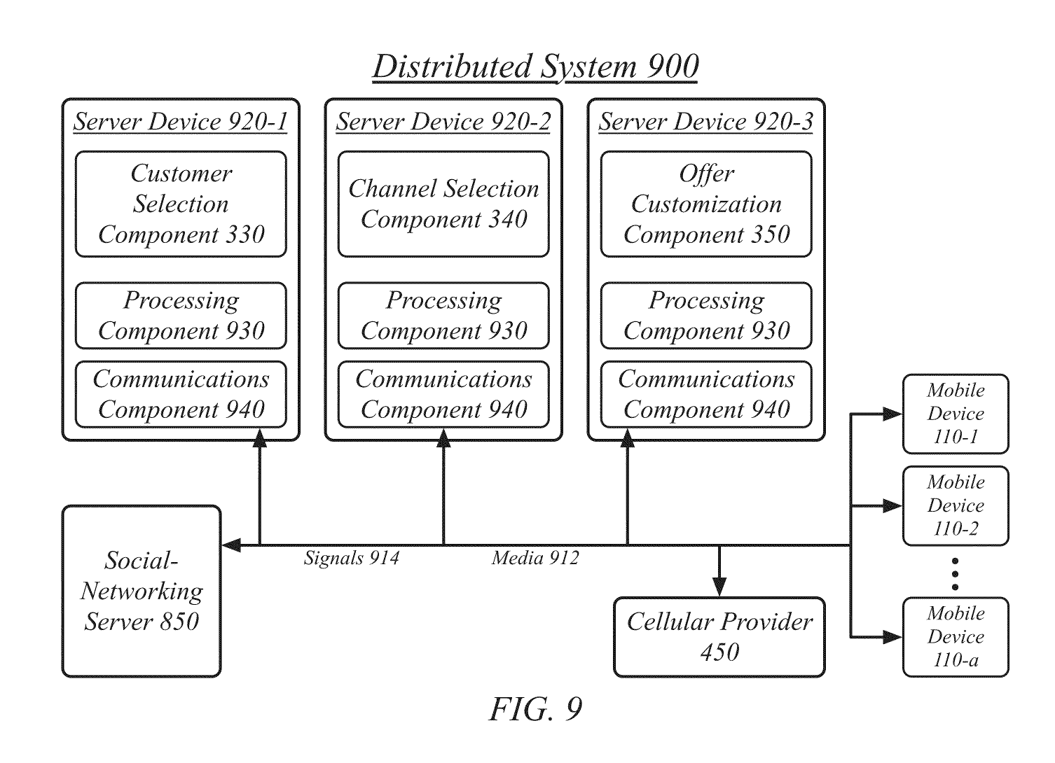

FIG. 9 illustrates a block diagram of a distributed system 900. The distributed system 900 may distribute portions of the structure and/or operations for the mobile offer communication system 100 across multiple computing entities. Examples of distributed system 900 may include without limitation a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

The distributed system 900 may comprise a plurality of server devices 920. In general, the plurality of server devices 920 may be the same or similar to the client device 820 as described with reference to FIG. 8. For instance, the plurality of server devices 920 may each comprise a processing component 930 and a communications component 940 which are the same or similar to the processing component 830 and the communications component 840, respectively, as described with reference to FIG. 8. In another example, the devices 920 may communicate over a communications media 912 using communications signals 914 via the communications components 940.

A first server device 920-1 may comprise or employ one or more client programs that operate to perform various methodologies in accordance with the described embodiments. In one embodiment, for example, the server device 920-1 may implement the customer selection component 330.

A second server device 920-2 may comprise or employ one or more client programs that operate to perform various methodologies in accordance with the described embodiments. In one embodiment, for example, the server device 920-2 may implement the channel selection component 340.

A third server device 920-3 may comprise or employ one or more client programs that operate to perform various methodologies in accordance with the described embodiments. In one embodiment, for example, the server device 920-3 may implement the offer customization component 350.

The server devices 920 may intercommunicate using the communications signals 914 in the performance of the operations of the mobile offers server 140. The server devices 920 may communicate with mobile devices 110, cellular provider 450, and social-networking server 850 in the performance of the operations of the mobile offers servers 140. It will be appreciated that additional server devices 920 beyond the three illustrated may be used, such as where multiple instances of one or more of the components are used in a distributed server environment. Similarly, the operations of the social-networking server 850 may be implemented across multiple computer devices.

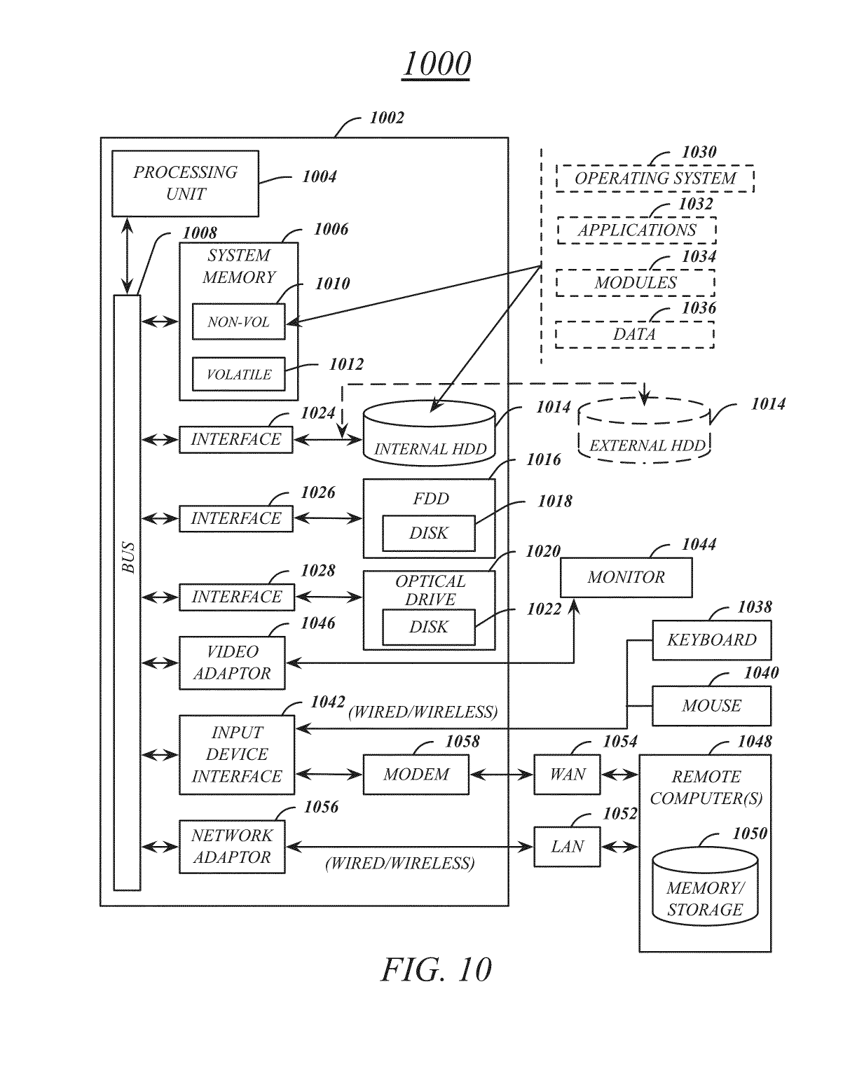

FIG. 10 illustrates an embodiment of an exemplary computing architecture 1000 suitable for implementing various embodiments as previously described. In one embodiment, the computing architecture 1000 may comprise or be implemented as part of an electronic device. Examples of an electronic device may include those described with reference to FIGS. 8 and 9, among others. The embodiments are not limited in this context.

As used in this application, the terms “system” and “component” are intended to refer to a computer-related entity, either hardware, a combination of hardware and software, software, or software in execution, examples of which are provided by the exemplary computing architecture 1000. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 1000 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 1000.

As shown in FIG. 10, the computing architecture 1000 comprises a processing unit 1004, a system memory 1006 and a system bus 1008. The processing unit 1004 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 1004.

The system bus 1008 provides an interface for system components including, but not limited to, the system memory 1006 to the processing unit 1004. The system bus 1008 can be any of several types of bus structure that may further interconnect to a memory bus (with or without a memory controller), a peripheral bus, and a local bus using any of a variety of commercially available bus architectures. Interface adapters may connect to the system bus 1008 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 1000 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 1006 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 10, the system memory 1006 can include non-volatile memory 1010 and/or volatile memory 1012. A basic input/output system (BIOS) can be stored in the non-volatile memory 1010.

The computer 1002 may include various types of computer-readable storage media in the form of one or more lower speed memory units, including an internal (or external) hard disk drive (HDD) 1014, a magnetic floppy disk drive (FDD) 1016 to read from or write to a removable magnetic disk 1018, and an optical disk drive 1020 to read from or write to a removable optical disk 1022 (e.g., a CD-ROM or DVD). The HDD 1014, FDD 1016 and optical disk drive 1020 can be connected to the system bus 1008 by a HDD interface 1024, an FDD interface 1026 and an optical drive interface 1028, respectively. The HDD interface 1024 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 1010, 1012, including an operating system 1030, one or more application programs 1032, other program modules 1034, and program data 1036. In one embodiment, the one or more application programs 1032, other program modules 1034, and program data 1036 can include, for example, the various applications and/or components of the system 100.

A user can enter commands and information into the computer 1002 through one or more wire/wireless input devices, for example, a keyboard 1038 and a pointing device, such as a mouse 1040. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 1004 through an input device interface 1042 that is coupled to the system bus 1008, but can be connected by other interfaces such as a parallel port, IEEE 1394 serial port, a game port, a USB port, an IR interface, and so forth.

A monitor 1044 or other type of display device is also connected to the system bus 1008 via an interface, such as a video adaptor 1046. The monitor 1044 may be internal or external to the computer 1002. In addition to the monitor 1044, a computer typically includes other peripheral output devices, such as speakers, printers, and so forth.

The computer 1002 may operate in a networked environment using logical connections via wire and/or wireless communications to one or more remote computers, such as a remote computer 1048. The remote computer 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wire/wireless connectivity to a local area network (LAN) 1052 and/or larger networks, for example, a wide area network (WAN) 1054. Such LAN and WAN networking environments are commonplace in offices and companies, and facilitate enterprise-wide computer networks, such as intranets, all of which may connect to a global communications network, for example, the Internet.

When used in a LAN networking environment, the computer 1002 is connected to the LAN 1052 through a wire and/or wireless communication network interface or adaptor 1056. The adaptor 1056 can facilitate wire and/or wireless communications to the LAN 1052, which may also include a wireless access point disposed thereon for communicating with the wireless functionality of the adaptor 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wire and/or wireless device, connects to the system bus 1008 via the input device interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with wire and wireless devices or entities using the IEEE 802 family of standards, such as wireless devices operatively disposed in wireless communication (e.g., IEEE 802.10 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.10x (a, b, g, n, etc.) to provide secure, reliable, fast wireless connectivity. A Wi-Fi network can be used to connect computers to each other, to the Internet, and to wire networks (which use IEEE 802.3-related media and functions).

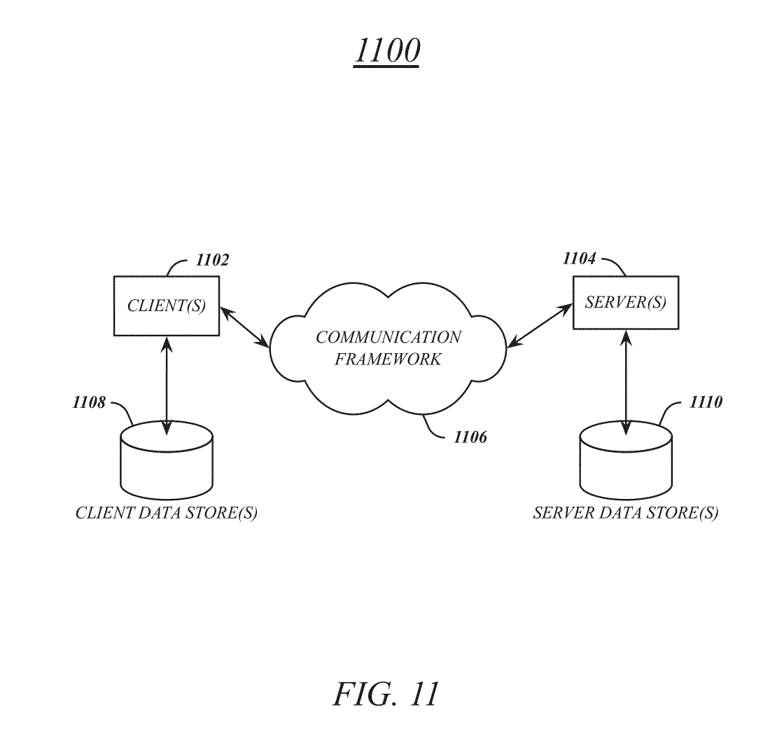

FIG. 11 illustrates a block diagram of an exemplary communications architecture 1100 suitable for implementing various embodiments as previously described. The communications architecture 1100 includes various common communications elements, such as a transmitter, receiver, transceiver, radio, network interface, baseband processor, antenna, amplifiers, filters, power supplies, and so forth. The embodiments, however, are not limited to implementation by the communications architecture 1100.

As shown in FIG. 11, the communications architecture 1100 comprises includes one or more clients 1102 and servers 1104. The clients 1102 may implement the client device 910. The servers 1104 may implement the server devices 920. The clients 1102 and the servers 1104 are operatively connected to one or more respective client data stores 1108 and server data stores 1110 that can be employed to store information local to the respective clients 1102 and servers 1104, such as cookies and/or associated contextual information.

The clients 1102 and the servers 1104 may communicate information between each other using a communication framework 1106. The communications framework 1106 may implement any well-known communications techniques and protocols. The communications framework 1106 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 1106 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 1102 and the servers 1104. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

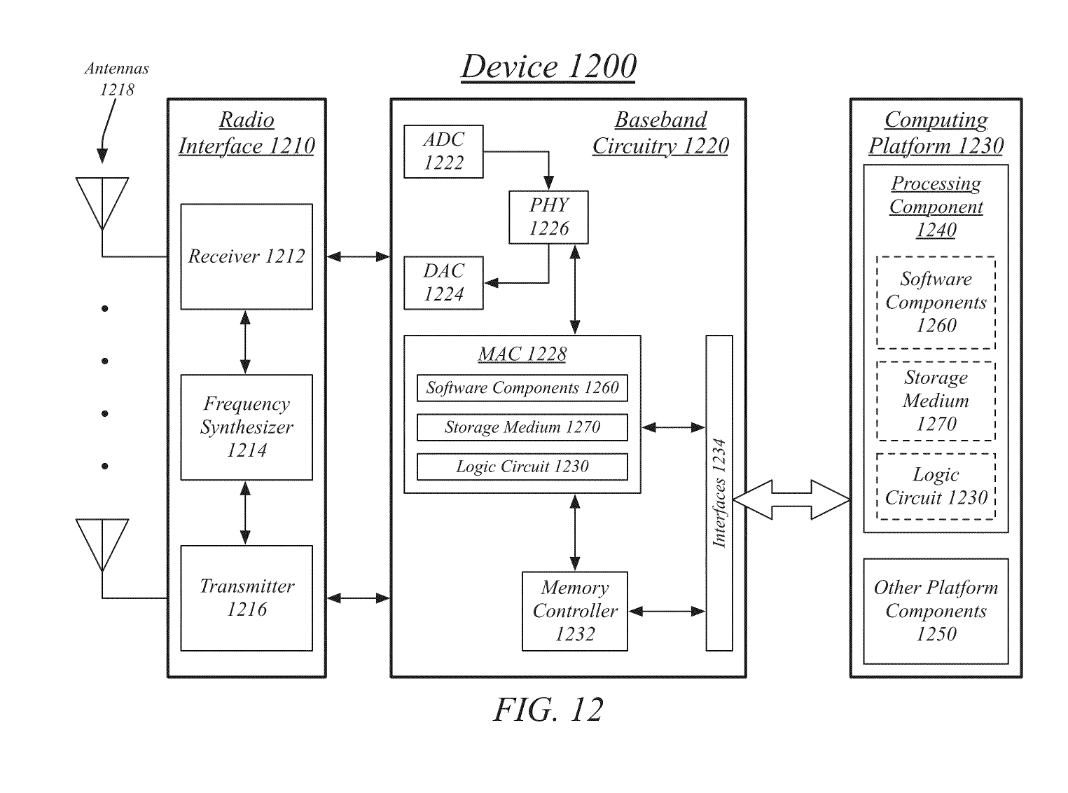

FIG. 12 illustrates an embodiment of a device 1200 for use in a multicarrier OFDM system, such as the system 100. Device 1200 may implement, for example, software components 1260 as described with reference to mobile offer communication system 100 and/or a logic circuit 1230. The logic circuit 1230 may include physical circuits to perform operations described for the system 100. As shown in FIG. 12, device 1200 may include a radio interface 1210, baseband circuitry 1220, and computing platform 1230, although embodiments are not limited to this configuration.

The device 1200 may implement some or all of the structure and/or operations for the system 100 and/or logic circuit 1230 in a single computing entity, such as entirely within a single device. Alternatively, the device 1200 may distribute portions of the structure and/or operations for the system 100 and/or logic circuit 1230 across multiple computing entities using a distributed system architecture, such as a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

In one embodiment, radio interface 1210 may include a component or combination of components adapted for transmitting and/or receiving single carrier or multi-carrier modulated signals (e.g., including complementary code keying (CCK) and/or orthogonal frequency division multiplexing (OFDM) symbols) although the embodiments are not limited to any specific over-the-air interface or modulation scheme. Radio interface 1210 may include, for example, a receiver 1212, a transmitter 1216 and/or a frequency synthesizer 1214. Radio interface 1210 may include bias controls, a crystal oscillator and/or one or more antennas 1218. In another embodiment, radio interface 1210 may use external voltage-controlled oscillators (VCOs), surface acoustic wave filters, intermediate frequency (IF) filters and/or RF filters, as desired. Due to the variety of potential RF interface designs an expansive description thereof is omitted.

Baseband circuitry 1220 may communicate with radio interface 1210 to process receive and/or transmit signals and may include, for example, an analog-to-digital converter 1222 for down converting received signals, a digital-to-analog converter 1224 for up converting signals for transmission. Further, baseband circuitry 1220 may include a baseband or physical layer (PHY) processing circuit 1256 for PHY link layer processing of respective receive/transmit signals. Baseband circuitry 1220 may include, for example, a processing circuit 1228 for medium access control (MAC)/data link layer processing. Baseband circuitry 1220 may include a memory controller 1232 for communicating with processing circuit 1228 and/or a computing platform 1230, for example, via one or more interfaces 1234.

In some embodiments, PHY processing circuit 1226 may include a frame construction and/or detection module, in combination with additional circuitry such as a buffer memory, to construct and/or deconstruct communication frames, such as radio frames. Alternatively or in addition, MAC processing circuit 1228 may share processing for certain of these functions or perform these processes independent of PHY processing circuit 1226. In some embodiments, MAC and PHY processing may be integrated into a single circuit.

The computing platform 1230 may provide computing functionality for the device 1200. As shown, the computing platform 1230 may include a processing component 1240. In addition to, or alternatively of, the baseband circuitry 1220, the device 1200 may execute processing operations or logic for the system 100 and logic circuit 1230 using the processing component 1240. The processing component 1240 (and/or PHY 1226 and/or MAC 1228) may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The computing platform 1230 may further include other platform components 1250. Other platform components 1250 include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

Device 1200 may be, for example, an ultra-mobile device, a mobile device, a fixed device, a machine-to-machine (M2M) device, a personal digital assistant (PDA), a mobile computing device, a smart phone, a telephone, a digital telephone, a cellular telephone, user equipment, eBook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, base station, node B, evolved node B (eNB), subscriber station, mobile subscriber center, radio network controller, router, hub, gateway, bridge, switch, machine, or combination thereof. Accordingly, functions and/or specific configurations of device 1200 described herein, may be included or omitted in various embodiments of device 1200, as suitably desired. In some embodiments, device 1200 may be configured to be compatible with protocols and frequencies associated one or more of the 3GPP LTE Specifications and/or IEEE 1202.16 Standards for WMANs, and/or other broadband wireless networks, cited herein, although the embodiments are not limited in this respect.

Embodiments of device 1200 may be implemented using single input single output (SISO) architectures. However, certain implementations may include multiple antennas (e.g., antennas 1218) for transmission and/or reception using adaptive antenna techniques for beamforming or spatial division multiple access (SDMA) and/or using MIMO communication techniques.

The components and features of device 1200 may be implemented using any combination of discrete circuitry, application specific integrated circuits (ASICs), logic gates and/or single chip architectures. Further, the features of device 1200 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the exemplary device 1200 shown in the block diagram of FIG. 12 may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein which form part of one or more embodiments. Rather, the operations are machine operations. Useful machines for performing operations of various embodiments include general purpose digital computers or similar devices.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

What is claimed is:

1. A computer-implemented method, comprising:
retrieving an offer from an offers store, the offer associated with an offer identifier, the offer associated with offer selection criteria;
searching a user information store to select a mobile user based on a match between the offer selection criteria and user information for the mobile user stored in the user information store;
transmitting, via a network interface, the offer to a mobile device associated with the mobile user, the mobile device identified by a mobile device identifier, the mobile device associated with a cellular provider for mobile service;
receiving, via the network interface, an acceptance of the offer from the mobile device; and
transmitting, via the network interface, a purchase order to the cellular provider, the purchase order comprising the offer identifier and the mobile device identifier, the purchase order indicating the acceptance of the offer to the cellular provider.

2. The method of claim 1, the user information comprising at least one of demographic information, user interest information, and user connection information for the mobile user derived from a social-networking service of which the mobile user is a member, the mobile user identified as the member of the social-networking service based on a phone number for the mobile device received from the cellular provider.

3. The method of claim 1, comprising:
selecting a set of mobile devices for offer testing;
transmitting the offer to the set of mobile devices;
receiving acceptances of the offer from at least a portion of the set of mobile devices;
performing machine learning to determine offer performance criteria for the offer; and
selecting at least one of the mobile user, a delivery channel to the mobile user, and a user-specific price based on the determined offer performance criteria.

4. The method of claim 1, the offer comprising at least one of a cellular voice package, a cellular data package, a short message service package, an application-specific data package, an event-specific data package, a cellular device, a cellular device accessory, and an offer to convert from pre-paid to subscription service.

5. The method of claim 1, the mobile user a member of a social-networking service, the offer including activation of a phone number for at least one of cellular voice service or short message service for the mobile device, the offer promoting social-networking notification of the activation of the phone number, further comprising:
transmitting a notification of an association of the phone number with the mobile user in the social-networking service.

6. The method of claim 1, the mobile user a member of a social-networking service, wherein the purchase order comprises subscriber information for the mobile user, further comprising:
auto-filling the subscriber information for the mobile user based on member information for the member in the social-networking service.

7. The method of claim 1, the offer comprising a listing of one or more approved delivery channels, comprising:
determining a plurality of available delivery channels for the mobile device based on the user information and the listing of one or more approved delivery channels, the available delivery channels comprising at least two or more of cellular voice, short message service, unstructured supplementary service data, and network-data-based advertisement;
selecting a delivery channel from the plurality of available delivery channels based on the user information for the mobile user in the user information store; and
transmitting the offer to the mobile device using the selected delivery channel.

8. The method of claim 7, the network-data-based advertisement transmitted to a mobile application on the mobile device via an advertisement delivery channel for the mobile application.

9. The method of claim 1, the offer transmitted to the mobile device comprising a user-specific price, the purchase order transmitted to the cellular provider comprising the user-specific price, further comprising:
customizing the offer to comprise the user-specific price based on the user information for the mobile user in the user information store.

10. An apparatus, comprising:
a processor circuit on a device;
a customer selection component operative on the processor circuit to retrieve an offer from an offers store, the offer associated with an offer identifier, the offer associated with offer selection criteria, search a user information store to select a mobile user based on a match between the offer selection criteria and user information for the mobile user stored in the user information store, transmit, via a network interface, the offer to a mobile device associated with the mobile user, the mobile device identified by a mobile device identifier, the mobile device associated with a cellular provider for mobile service, receive, via the network interface, an acceptance of the offer from the mobile device, and transmit, via the network interface, a purchase order to the cellular provider, the purchase order comprising the offer identifier and the mobile device identifier, the purchase order indicating the acceptance of the offer to the cellular provider.

11. The apparatus of claim 10, the user information comprising at least one of demographic information, user interest information, and user connection information for the mobile user derived from a social-networking service of which the mobile user is a member, the mobile user identified as the member of the social-networking service based on a phone number for the mobile device received from the cellular provider, the offer comprising at least one of a cellular voice package, a cellular data package, a short message service package, an application-specific data package, an event-specific data package, a cellular device, a cellular device accessory, and an offer to convert from pre-paid to subscription service using auto-filled subscriber information for the mobile user based on member information for the member in the social-networking service.

12. The apparatus of claim 10, the customer selection component operative to select a set of mobile devices for offer testing, transmit the offer to the set of mobile devices, receive acceptances of the offer from at least a portion of the set of mobile devices, perform machine learning to determine offer performance criteria for the offer, and select the mobile user based on the determined offer performance criteria.

13. The apparatus of claim 10, the mobile user a member of a social-networking service, the offer including activation of a phone number for at least one of cellular voice service or short message service for the mobile device, the offer promoting social-networking notification of the activation of the phone number, the customer selection component operative to transmit a notification of an association of the phone number with the mobile user in the social-networking service.

14. The apparatus of claim 10, the offer comprising a listing of one or more approved delivery channels, further comprising:
a channel selection component operative to determine a plurality of available delivery channels for the mobile device based on the user information and the listing of one or more approved delivery channels, the available delivery channels comprising at least two or more of cellular voice, short message service, unstructured supplementary service data, and network-data-based advertisement, select a delivery channel from the plurality of available delivery channels based on the user information for the mobile user in the user information store, and transmit the offer to the mobile device using the selected delivery channel.

15. The apparatus of claim 10, the offer transmitted to the mobile device comprising a user-specific price, the purchase order transmitted to the cellular provider comprising the user-specific price, further comprising:
an offer customization component operative to customize the offer to comprise the user-specific price based on the user information for the mobile user in the user information store.

16. At least one computer-readable storage medium comprising instructions that, when executed, cause a system to:
retrieve an offer from an offers store, the offer associated with an offer identifier, the offer associated with offer selection criteria, the offer comprising at least one of a cellular voice package, a cellular data package, a short message service package, an application-specific data package, an event-specific data package, a cellular device, a cellular device accessory, and an offer to convert from pre-paid to subscription service;
search a user information store to select a mobile user based on a match between the offer selection criteria and user information for the mobile user stored in the user information store, the user information comprising at least one of demographic information, user interest information, and user connection information for the mobile user derived from a social-networking service of which the mobile user is a member, the mobile user identified as the member of the social-networking service based on a phone number for the mobile device received from the cellular provider;
transmit, via a network interface, the offer to a mobile device associated with the mobile user, the mobile device identified by a mobile device identifier, the mobile device associated with a cellular provider for mobile service;
receive, via the network interface, an acceptance of the offer from the mobile device; and
transmit, via the network interface, a purchase order to the cellular provider, the purchase order comprising the offer identifier and the mobile device identifier, the purchase order indicating the acceptance of the offer to the cellular provider.

17. The computer-readable storage medium of claim 16, comprising further instructions that, when executed, cause a system to:
select a set of mobile devices for offer testing;
transmit the offer to the set of mobile devices;
receive acceptances of the offer from at least a portion of the set of mobile devices;
perform machine learning to determine offer performance criteria for the offer; and
select at least one of the mobile user, a delivery channel to the mobile user, and a user-specific price based on the determined offer performance criteria.

18. The computer-readable storage medium of claim 16, the offer including activation of a phone number for at least one of cellular voice service or short message service for the mobile device, the offer promoting social-networking notification of the activation of the phone number, comprising further instructions that, when executed, cause a system to:
transmit a notification of an association of the phone number with the mobile user in the social-networking service

19. The computer-readable storage medium of claim 16, the offer comprising a listing of one or more approved delivery channels, comprising further instructions that, when executed, cause a system to:
determine a plurality of available delivery channels for the mobile device based on the user information and the listing of one or more approved delivery channels, the available delivery channels comprising at least two or more of cellular voice, short message service, unstructured supplementary service data, and network-data-based advertisement;
select a delivery channel from the plurality of available delivery channels based on the user information for the mobile user in the user information store; and
transmit the offer to the mobile device using the selected delivery channel.

20. The computer-readable storage medium of claim 16, the offer transmitted to the mobile device comprising a user-specific price, the purchase order transmitted to the cellular provider comprising the user-specific price, comprising further instructions that, when executed, cause a system to:
customize the offer to comprise the user-specific price based on the user information for the mobile user in the user information store.
